(19) United States
(12) Patent Application Publication
(10) Pub. No.: US 2009/0221349 A1
(43) Pub. Date: Sep. 3, 2009

(54) Gaming Machine Providing Chance Of Payout For Loss Game And Playing Method Thereof

(75) Inventor: Kazumasa YOSHIZAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE CORP., Tokyo (JP)

(21) Appl. No.: 12/178,271

(22) Filed: Jul. 23, 2008

Related U.S. Application Data
(60) Provisional application No. 61/033,081, filed on Mar. 3, 2008.

(51) Int. Cl. A63F 13/00; A63F 9/24

(52) U.S. Cl. 463/20; 463/31; 463/25

(57) ABSTRACT

A slot machine 1 includes a central liquid crystal panel 5B that has an arrangement area consisting of 5 columns and 3 rows (display windows 151 to 155) of a matrix type and arranges symbols 180 in the arrangement area, a coin insertion slot 12 that inserts a coin, a ready-to-win loss counter 92 that calculates a count, and a main control board 71. The main control board 71 rearranges the symbols 180 so that a timing at which the symbols are rearranged in at least one arrangement area is different from a timing at which the symbols are rearranged in another arrangement area, after a coin is inserted, generates a step in which there is a possibility that a predetermined combination is generated due to a relation between symbols 180 of an area already rearranged and symbols 180 to be rearranged in any one rearrangement area, before the symbols 180 are rearranged in that area, awards a base payout, when the predetermined combination is generated by the symbols 180 rearranged, calculates a count when the predetermined combination is not generated by the symbols 180 rearranged, and awards a special payout when the count reaches a predetermined value.

### CROSS REFERENCE TO RELATED APPLICATION

The present application claims priority from provisional application No. 61/033,081, which was filed on Mar. 3, 2008, the entire disclosure of which is herein incorporated by reference.

### BACKGROUND OF THE INVENTION

1. Field of the Invention

The invention relates to a gaming machine and a playing method thereof.

2. Description of Related Art

In a conventional slot machine, when a player inserts a game medium such as coin, bill and the like into an insertion slot of the slot machine and pushes a spin button, symbols are scrolled on a display provided to a front of a cabinet and then stopped automatically.

In such slot machine, as disclosed in a U.S. Pat. No. 6,604,999B2, U.S. Patent Publication Nos. US2002065124A1 or US20040053676A1, for example, when symbols stopped on a winning line constitute a predetermined combination, a predetermined number of game media are paid out. In the slot machine, a player determines a game value to be inserted and inserts it into the insertion slot of the slot machine to execute a game. When a predetermined combination (winning) is obtained, the player is provided with a payout of a game value. When a result of the game is a loss, the player loses the game value inserted.

Even when a stop control of reels is performed through an operation of a stop button or each reel is automatically stopped at a random timing, as the game is repeated many times in the slot machine, a ratio (payout rate) of an integrated value of the game value payouts obtained by the winnings up to now and the game values inserted into the insertion slot of the slot machine before each game is started comes close to an approximately constant value. Accordingly, a probability of a winning occurrence that a privilege game (bonus game), in which a payout of many game values is obtained with only one winning or a winning is apt to be made very easily, can be executed is typically set as one per 100 games, for example, considering the payout rate.

Since the occurrence frequency of the winning is determined in a probability manner, it may be possible that a big winning is generated two times when 100 games are executed or no big winning is generated even when 200 or 300 games are executed. When a winning is not obtained even though the game is executed many times, a loss of the game value is increased and thus the player may be sick of the game and lose an interest in the game.

In this regard, in order to solve the problem that a player is sick of a game and loses an interest in the game, there is provided a slot machine in which a player does not lose an interest in a game even when the game value is increased. For example, refer to U.S. Pat. Nos. 5,178,390; 5,820,459; 6,695,697; 6,254,483; 5,611,730; 5,639,088; 6,257,981; 6,234,896; 6,001,016; 6,273,820; 6,224,482; 4,669,731; 6,244,957; 5,910,048; 5,695,402; 6,003,013; 4,283,709; 4,964,638; 6,089,980; 5,280,909; 5,702,303; 6,270,409; 5,770,533; 5,836,817; 6,932,704; 6,932,707; 4,837,728; 4,624,459; 5,564,700 and 5,890,963, U.S. Patent Publication No. 2003/0069073, European Patent Publication Nos. 1192975; 1302914; 1544811; 1477947; 1351180 and 0631798, Germany Patent Publication Nos. 4137010; 3712841; 3242890 and 10049444, England Patent Publication No. 2326830, International Patent Publication Nos. 03/083795, 07/026396, 07/026401, 07/026400, 07/026406, 07/026399, 07/026407, 07/026402, 07/026403 and 07026404. These slot machines have a function of awarding a payout or bonus, on condition of a predetermined game-number or loss game-number.

However, it is difficult to enable a player to continuously have an expectation for a payout or bonus until a predetermined game-number or loss game-number is increased and a condition is thus reached.

An object of the invention is to provide a gaming machine capable of awarding a special payout different from a base payout for a loss state in which a predetermined combination (winning) is not made after a gaming state is shifted to a “ready-to-win state,” thereby decreasing a player's disappointment in the loss and maintaining an expectation for the special payout, and a playing method thereof.

### SUMMARY OF THE INVENTION

The invention provides a gaming machine including a display that has an arrangement area of a matrix type and arranges a plurality of symbols in the arrangement area; a game value insertion means that inserts a game value; a count means that calculates a count; and a controller that is programmed to operate as described in the steps of (a1) to (a5). Specifically, the controller operates (a1) to rearrange the symbols so that a timing at which the symbols are rearranged in at least one arrangement area is different from a timing at which the symbols are rearranged in another arrangement area, after a game value is inserted; (a2) to generate a step in which there is a possibility that a predetermined combination is generated due to a relation between symbols of an area already rearranged and symbols to be rearranged in any one rearrangement area, before the symbols are rearranged in that area; (a3) to award a base payout, when the predetermined combination is generated by the symbols rearranged; (a4) to calculate the count, when the predetermined combination is not generated by the symbols rearranged; and (a5) to award a special payout, when the count reaches a predetermined value.

According to the above structure, a step (one-short-loss) is generated in which there is a possibility that a predetermined combination is generated due to a relation between symbols of an area already rearranged and symbols to be rearranged in any one rearrangement area, before the symbols are rearranged in that area. Then, when the predetermined combination is not generated, a count is calculated. When the count reaches a predetermined value, a special payout can be awarded. Thereby, even when a predetermined combination awarding a base payout is not generated, a player may have an expectation for a special payout. In addition, since it is conditioned that a step is generated in which there is a possibility that a predetermined combination is generated due to a relation between symbols of an area already rearranged and symbols to be rearranged in any one rearrangement area, before the symbols are rearranged in that area, so as to obtain a special payout, the frequency to be counted is decreased. Thereby, a predetermined value of the count is set low, so that a player may feel closer to an expectation that a special payout will be awarded and maintain an expectation for the special payout, as compared to a case where a predetermined value of the count is set high.

In addition, according to the invention, the controller resets the value counted in the count means by a predetermined condition.

According to the above structure, it is possible to reset the value calculated in the count means by a predetermined condition. Thereby, when a count is reset on condition that a bonus game is generated, for example, a special payout is not obtained and a payout by the bonus game can be instead obtained. Accordingly, it may be possible that a game is continued without deteriorating a sense of satisfaction of a player.

In addition, the invention provides a gaming machine including a display that has an arrangement area of a matrix type and at least one payline and arranges a plurality of symbols in the arrangement area; a game value insertion means that inserts a game value; a count means that calculates a count; and a controller that is programmed to operate as described in the steps of (b1) to (b5). Specifically, the controller operates (b1) to rearrange the symbols so that a timing at which the symbols are rearranged in at least one arrangement area is different from a timing at which the symbols are rearranged in another arrangement area, after a game value is inserted; (b2) to generate a step in which there is a possibility that a predetermined combination is generated on the payline due to a relation between symbols of an area already rearranged and symbols to be rearranged in any one rearrangement area, before the symbols are rearranged in that area; (b3) to award a base payout, when the predetermined combination is generated on the payline by the symbols rearranged; (b4) to calculate the count, when the predetermined combination is not generated on the payline by the symbols rearranged; and (b5) to award a special payout, when the count reaches a predetermined value.

According to the above structure, in a slot machine having a payline, a step is generated in which there is a possibility that a predetermined combination is generated on a payline due to a relation between symbols of an area already rearranged and symbols to be rearranged in any one rearrangement area, before the symbols are rearranged in that area on any one payline. Then, when the predetermined combination is not generated, a count is calculated. When the count reaches a predetermined value, a special payout can be awarded. Thereby, even when a predetermined combination awarding a base payout is not generated, a player may have an expectation for a special payout. In addition, since it is conditioned that a step is generated in which there is a possibility that a predetermined combination is generated due to a relation between symbols of an area already rearranged and symbols to be rearranged in any one rearrangement area, before the symbols are rearranged in that area on any one payline, so as to obtain a special payout, the frequency to be counted is decreased. Thereby, a predetermined value of the count is set low, so that a player may feel closer to an expectation that a special payout will be awarded and maintain an expectation for the special payout, as compared to a case where a predetermined value of the count is set high.

In addition, according to the invention, the controller resets the value counted in the count means by a predetermined condition.

According to the above structure, it is possible to reset the value calculated in the count means by a predetermined condition. Thereby, when a count is reset on condition that a bonus game is generated, for example, a special payout is not obtained and a payout by the bonus game can be instead obtained. Accordingly, it may be possible that a game is continued without deteriorating a sense of satisfaction of a player.

In addition, the invention provides a gaming machine including a display that has an arrangement area of a matrix type and arranges a plurality of scatter symbols in the arrangement area; a game value insertion means that inserts a game value; a count means that calculates a count; and a controller that is programmed to operate as described in the steps of (c1) to (c5). Specifically, the controller operates (c1) to rearrange the scatter symbols so that a timing at which the symbols are rearranged in at least one arrangement area is different from a timing at which the symbols are rearranged in another arrangement area, after a game value is inserted; (c2) to generate a step in which there is a possibility that a predetermined number of scatter symbols are rearranged due to a relation between scatter symbols of an area already rearranged and scatter symbols to be rearranged in any one rearrangement area, before the scatter symbols are rearranged in that area; (c3) to award a base payout, when the predetermined number of scatter symbols are rearranged by the scatter symbols rearranged; (c4) to calculate the count, when the predetermined number of scatter symbols are not rearranged by the scatter symbols rearranged; and (c5) to award a special payout, when the count reaches a predetermined value.

According to the above structure, in a slot machine having scatter symbols, a step is generated in which there is a possibility that a predetermined number of scatter symbols are rearranged due to a relation between scatter symbols of an area already rearranged and scatter symbols to be rearranged in any one rearrangement area, before the scatter symbols are rearranged in that area. Then, when a predetermined number of scatter symbols are not rearranged, a count is calculated. When the count reaches a predetermined value, a special payout can be awarded. Thereby, even when a predetermined number of scatter symbols are not rearranged, a player may have an expectation for a special payout. In addition, since it is conditioned that a step is generated in which there is a possibility that a predetermined number of scatter symbols are rearranged due to a relation between scatter symbols of an area already rearranged and scatter symbols to be rearranged in any one rearrangement area, before the scatter symbols are rearranged in that area, so as to obtain a special payout, the frequency to be counted is decreased. Thereby, a predetermined value of the count is set low, so that a player may feel closer to an expectation that a special payout will be awarded and maintain an expectation for the special payout, as compared to a case where a predetermined value of the count is set high.

In addition, according to the invention, the controller resets the value counted in the count means by a predetermined condition.

According to the above structure, it is possible to reset the value calculated in the count means by a predetermined condition. Thereby, when a count is reset on condition that a bonus game is generated, for example, a special payout is not obtained and a payout by the bonus game can be instead obtained. Accordingly, it may be possible that a game is continued without deteriorating a sense of satisfaction of a player.

In addition, the invention provides a gaming machine including a display that has an arrangement area of a matrix type and arranges a plurality of symbols in the arrangement area; a first game value insertion means that inserts a game value; a second game value insertion means that inserts a game value; a count means that calculates a count; and a controller that is programmed to operate as described in the steps of (d1) to (d5). Specifically, the controller operates (d1) to rearrange the symbols so that a timing at which the symbols are rearranged in at least one arrangement area is different from a timing at which the symbols are rearranged in another arrangement area, after a game value is inserted in the first game value insertion means; (d2) to generate a step in which there is a possibility that a predetermined combination is generated due to a relation between symbols of an area already rearranged and symbols to be rearranged in any one rearrangement area, before the symbols are rearranged in that area; (d3) to award a base payout, when the predetermined combination is generated by the symbols rearranged; (d4) to calculate the count, when a game value is inserted into the second game value insertion means and the predetermined combination is not generated by the symbols rearranged; and (d5) to award a special payout, when the count reaches a predetermined value.

According to the above structure, the count means can calculate a count only when a game value is inserted into the second game value insertion means. Thereby, a player can freely select whether to obtain a chance that a special payout will be awarded.

In addition, according to the invention, the controller resets the value counted in the count means by a predetermined condition.

According to the above structure, it is possible to reset the value calculated in the count means by a predetermined condition. Thereby, when a count is reset on condition that a bonus game is generated, for example, a special payout is not obtained and a payout by the bonus game can be instead obtained. Accordingly, it may be possible that a game is continued without deteriorating a sense of satisfaction of a player.

In addition, the invention provides a playing method of a gaming machine that arranges a plurality of symbols in an arrangement area of a matrix type provided to a display. The method includes the steps of rearranging the symbols so that a timing at which the symbols are rearranged in at least one arrangement area is different from a timing at which the symbols are rearranged in another arrangement area, after a game value is inserted; generating a step in which there is a possibility that a predetermined combination is generated due to a relation between symbols of an area already rearranged and symbols to be rearranged in any one rearrangement area, before the symbols are rearranged in that area; awarding a base payout, when the predetermined combination is generated by the symbols rearranged; calculating a count of a count means, when the predetermined combination is not generated by the symbols rearranged; and awarding a special payout, when the count reaches a predetermined value.

According to the playing method of the gaming machine, a step is generated in which there is a possibility that a predetermined combination is generated due to a relation between symbols of an area already rearranged and symbols to be rearranged in any one rearrangement area, before the symbols are rearranged in that area. Then, when the predetermined combination is not generated, a count is calculated. When the count reaches a predetermined value, a special payout can be awarded. Thereby, even when a predetermined combination awarding a base payout is not generated, a player may have an expectation for a special payout. In addition, since it is conditioned that a step is generated in which there is a possibility that a predetermined combination is generated due to a relation between symbols of an area already rearranged and symbols to be rearranged in any one rearrangement area, before the symbols are rearranged in that area, so as to obtain a special payout, the frequency to be counted is decreased. Thereby, a predetermined value of the count is set low, so that a player may feel closer to an expectation that a special payout will be awarded and maintain an expectation for the special payout, as compared to a case where a predetermined value of the count is set high.

### BRIEF DESCRIPTION OF THE DRAWINGS

Other and further objects, features and advantages of the invention will appear more fully from the following description taken in connection with the accompanying drawings, in which:

FIG. 1 illustrates a playing method of a slot machine;

FIG. 2 is a block diagram of a gaming machine;

FIG. 3 is a perspective view showing an external appearance of a slot machine;

FIG. 4 illustrates a display screen when a ready-to-win loss is made;

FIG. 5 illustrates a display screen at a time when an internal winning combination is made;

FIG. 6 illustrates a display screen in a bonus game;

FIG. 7 shows symbols and code numbers thereof;

FIG. 8 is a block diagram showing an overall electrical structure of a slot machine;

FIG. 9 is a block diagram showing an electrical structure of a sub control board of a slot machine;

FIG. 10 illustrates a winning combination lottery table for a base game;

FIG. 11 illustrates a payout table for a base game;

FIG. 12 illustrates a winning combination lottery table for a bonus game;

FIG. 13 illustrates a payout table for a bonus game;

FIG. 14 is a flow chart of an initial process that is executed in a slot machine;

FIG. 15 is a flow chart of a game executing process that is executed in a slot machine;

FIG. 16 is a flow chart of a bonus game process that is executed in a slot machine; and

FIG. 17 is a flow chart of a rescue pay executing process that is executed in a slot machine.

### DESCRIPTION OF THE PREFERRED EMBODIMENTS

Hereinafter, a gaming machine according to an embodiment of the invention and a playing method thereof will be described.

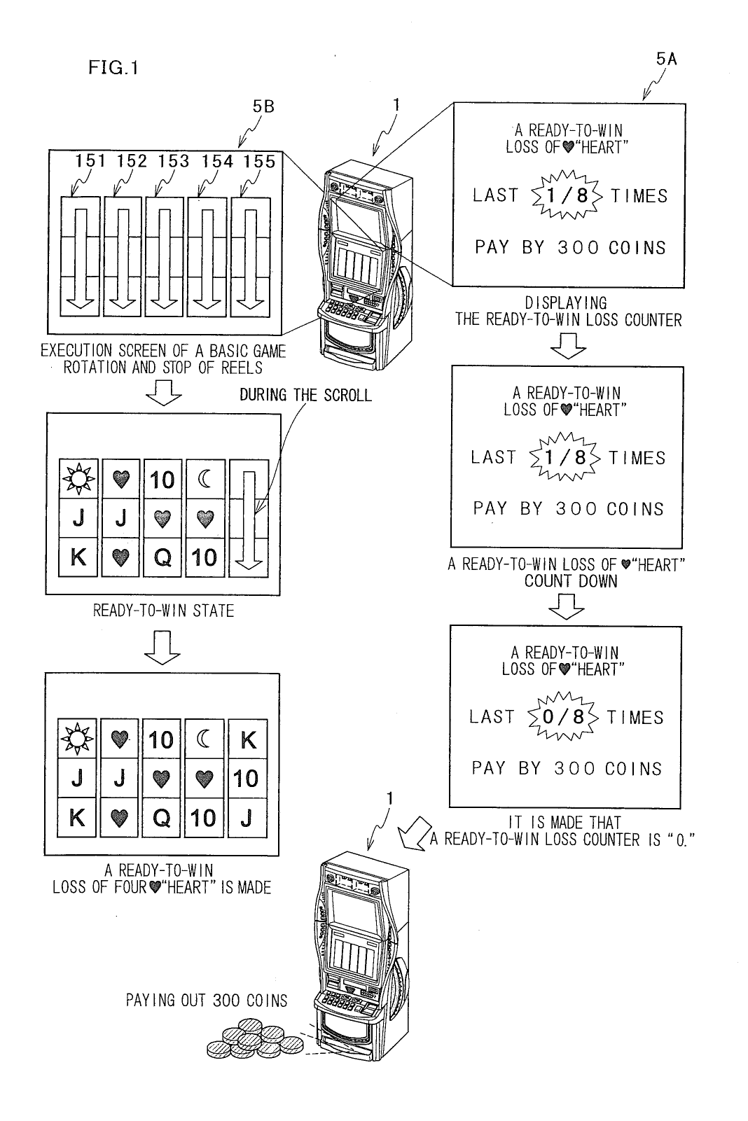

As shown in FIG. 1, there is provided a playing method of a gaming machine that arranges a plurality of symbols in an arrangement area of a matrix type provided to a display. The method includes the steps of rearranging the symbols so that a timing at which the symbols are rearranged in at least one arrangement area is different from a timing at which the symbols are rearranged in another arrangement area, after a game value is inserted; generating a step in which there is a possibility that a predetermined combination is generated due to a relation between symbols of an area already rearranged and symbols to be rearranged in any one rearrangement area, before the symbols are rearranged in that area; awarding a base payout, when the predetermined combination is generated by the symbols rearranged; calculating a count of a count means, when the predetermined combination is not generated by the symbols rearranged (referred to as a “ready-to-win loss” in this embodiment); awarding a special payout, when the count reaches a predetermined value; and resetting a value calculated in the count means by a predetermined condition.

In addition, the “ready-to-win loss” of this embodiment means that while one of symbols is rearranged, after another symbols are rearranged as symbols constituting a combination of symbols awarding a base payout, i.e., after it is shifted to a “ready-to-win state,” the symbols are not rearranged as a combination of symbols awarding a base payout. For example, in this embodiment, it includes a state that four symbols of “HEART” 182 are rearranged in an arrangement area, and the like. Meantime, a ready-to-win loss counter 92, which will be described later, is described as a counter that calculates the ready-to-win loss.

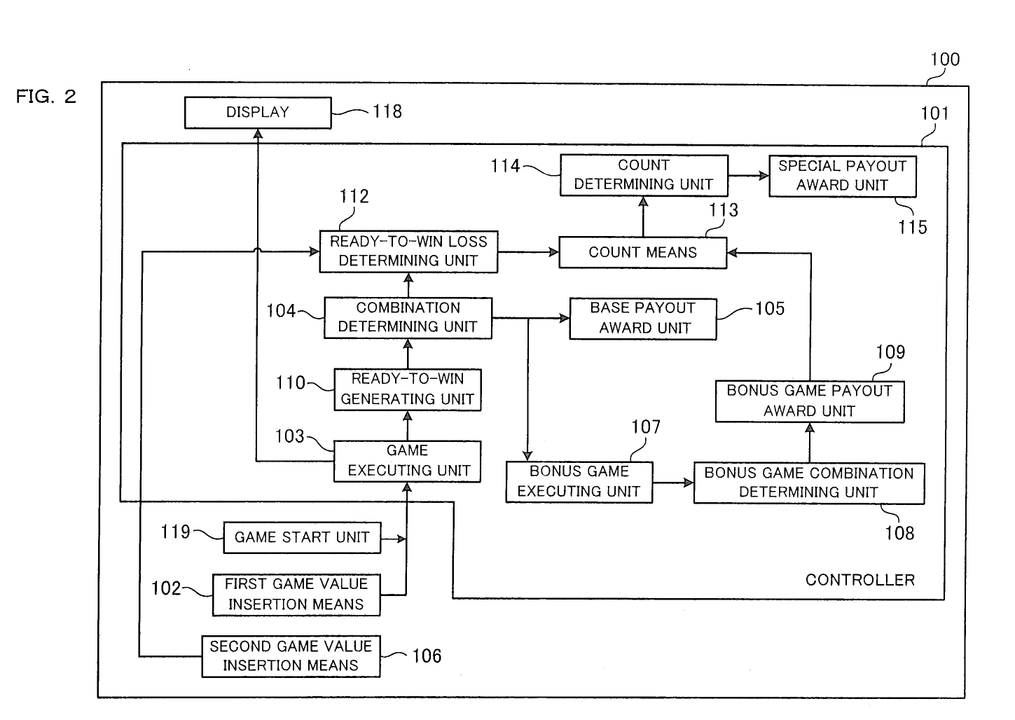

A gaming machine 100 that executes the above playing method includes a game start unit 119, a first game value insertion means 102, a second game value insertion means 106, a controller 101 and a display 118, as shown in FIG. 2. In addition, the display 118 is structured to arrange symbols 180.

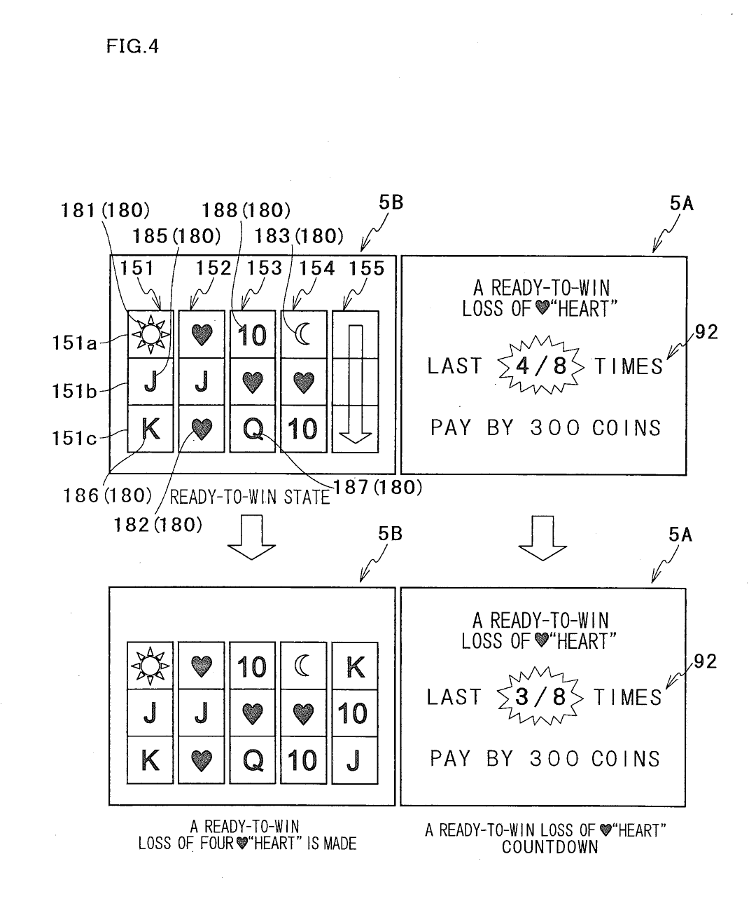

Here, the “arrangement” means a state in which the symbols 180 are allowed to be visible with naked eyes of an exterior player. In other words, in FIG. 4, it means a state that the symbols 180 are displayed on display windows 151 to 155. In the meantime, the “rearrangement” means arranging the symbols 180 again after dismissing the arrangement of the symbols.

The display 118 may be a mechanical structure with a reel device for arranging the symbols 180 by rotation of a reel or electrical structure with a video reel on which an image is displayed for arranging the symbols 180. Further, the display 118 may be a structure of combining a mechanical structure (reel) and an electrical structure (video reel). The electrical structure may include a liquid crystal display device, a CRT (cathode-ray tube) device, a plasma display device and the like. In addition, any number of the display windows 151 to 155 may be provided. A detailed structure of the display 118 will be described later.

(Controller 101)

The controller 101 is structured to execute a first process of rearranging the symbols so that a timing at which the symbols are rearranged in at least one arrangement area is different from a timing at which the symbols are rearranged in another arrangement area, after a game value is inserted; a second process of generating a step in which there is a possibility that a predetermined combination is generated due to a relation between symbols of an area already rearranged and symbols to be rearranged in any one rearrangement area, before the symbols are rearranged in that area; a third process of awarding a base payout, when the predetermined combination is generated by the symbols rearranged; a fourth process of calculating a count of a count means, when the predetermined combination is not generated by the symbols rearranged; a fifth process of awarding a special payout, when the count reaches a predetermined value; and a sixth process of resetting a value calculated in the count means by a predetermined condition. In other words, the controller 101 includes the six processes.

The controller 101 includes a game executing unit 103, a ready-to-win generating unit 110, a combination determining unit 104, a base payout award unit 105, a bonus game executing unit 107, a bonus game combination determining unit 108, a bonus game payout award unit 109, a ready-to-win loss determining unit 112, a count means 113, a count determining unit 114 and a special payout award unit 115.

(Operation of the Controller 101)

In the followings, an operation of the controller 101 will be described. Firstly, after a game value is inserted into the first game value insertion means 102, the game executing unit 103 starts a variable display of the arranged symbols 180 on the display 118 with a game start signal, as trigger, from the game start unit 119. Then, the controller rearranges the symbols 180 so that a timing at which the symbols are rearranged in at least one arrangement area is different from a timing at which the symbols are rearranged in another arrangement area, after the variable display is started. In other words, the controller 101 executes the first process.

In addition, in the first process, the ready-to-win generating unit 110 generates a step in which there is a possibility that a predetermined combination is generated due to a relation between symbols of an area already rearranged and symbols to be rearranged in any one rearrangement area, before the symbols are rearranged in that area (“ready-to-win state”). In other words, the controller 101 executes the second process.

In addition, when the combination determining unit 104 determines that the predetermined combination is generated by the symbols rearranged, the controller awards a base payout in the base payout award unit 105. In other words, the controller 101 executes the third process.

In addition, when the ready-to-win loss determining unit 112 determines that the predetermined combination is not generated by the symbols rearranged via the “ready-to-win state,” the controller calculates a count of the count means 113, on condition that a game value is inserted into the second game value insertion means 106. In other words, the controller 101 executes the fourth process.

In addition, when the count determining unit 114 determines that a value counted with the count means 113 reaches a predetermined value, the controller awards a special payout in the special payout award unit 115. In other words, the controller 101 executes the fifth process.

In addition, a bonus game is executed in the bonus game executing unit 107. Then, on condition that a game value is awarded as a payout of the bonus game in the bonus game payout award unit 109, based on a combination determined by the bonus game combination determining unit 108, the controller resets the value calculated in the count means 113. In other words, the controller 101 executes the sixth process.

In the meantime, each block of the controller 101 may be structured with a hardware or software, as required.

As clearly seen from the above operations, the gaming machine 100 is structured to arrange symbols in an arrangement area of a matrix type provided to a display and realizes a playing method of the gaming machine 100 including the steps of rearranging the symbols so that a timing at which the symbols are rearranged in at least one arrangement area is different from a timing at which the symbols are rearranged in another arrangement area, after a game value is inserted; generating a step in which there is a possibility that a predetermined combination is generated due to a relation between symbols of an area already rearranged and symbols to be rearranged in any one rearrangement area, before the symbols are rearranged in that area; awarding a base payout, when the predetermined combination is generated by the symbols rearranged; calculating a count of a count means, when the predetermined combination is not generated by the symbols rearranged (referred to as a “ready-to-win loss” in this embodiment); awarding a special payout, when the count reaches a predetermined value; and resetting a value calculated in the count means by a predetermined condition.

According to the above structure, a step is generated (ready-to-win state) in which there is a possibility that a predetermined combination is generated due to a relation between symbols of an area already rearranged and symbols to be rearranged in any one rearrangement area, before the symbols are rearranged in that area. Then, when the predetermined combination is not generated, a count is calculated. When the count reaches a predetermined value, a special payout can be awarded. Thereby, even when a predetermined combination awarding a base payout is not generated, a player may have an expectation for a special payout. In addition, since it is conditioned that a step is generated in which there is a possibility that a predetermined combination is generated due to a relation between symbols of an area already rearranged and symbols to be rearranged in any one rearrangement area, before the symbols are rearranged in that area, so as to obtain a special payout, the frequency to be counted is decreased. Thereby, a predetermined value of the count is set low, so that a player may feel closer to an expectation that a special payout will be awarded and maintain an expectation for the special payout, as compared to a case where a predetermined value of the count is set high.

In addition, when a predetermined condition is fulfilled, a value calculated in the count means 113 can be reset. Thereby, when a count is reset on condition that a bonus game is generated, for example, a special payout is not obtained and a payout by the bonus game can be instead obtained. Accordingly, it may be possible that a game is continued without deteriorating a sense of satisfaction of a player.

### Embodiments

(Mechanical Structure of the Slot Machine 1)

In the followings, an embodiment will be described in which the gaming machine 100 structured as described above is applied to a slot machine 1 and is thus structured mechanically and electrically. Meantime, the “rescue pay,” which will be described later, means a function that the rescue pay function can be used by inserting a predetermined game value before a game is started and a special payout can be obtained when a predetermined number of times of the “ready-to-win loss” appears.

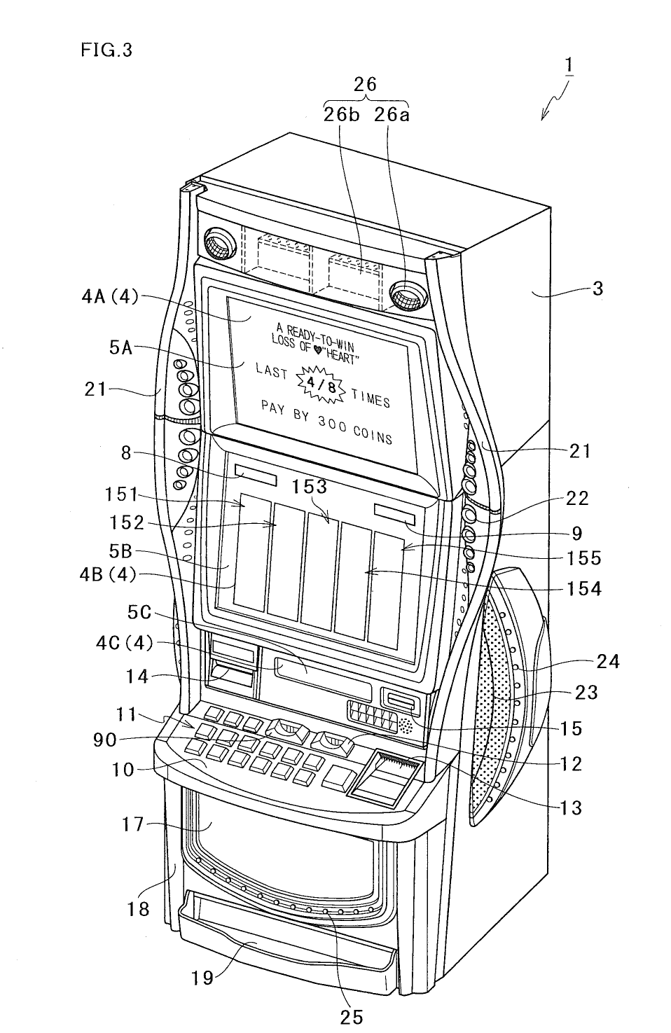

As shown in FIG. 3, the slot machine 1 of this embodiment is an upright-type slot machine provided in a game arcade such as casino and the like and has a cabinet 3 for receiving electrical or mechanical parts therein so as to execute a predetermined game aspect. As a display unit 4 for displaying the game information based on a game operation of a player, there are provided an upper variable display unit 4A, a central variable display unit 4B and a lower variable display unit 4C, for example. Each of the display units 4A, 4B, 4C is attached to a front of the cabinet 3 that is longitudinally long.

The upper variable display unit 4A is a display unit on which a player fixes the eyes during a unit game and has a transparent upper liquid crystal panel 5A that is fixed to the front door of the cabinet 3. The upper liquid crystal panel 5A displays a variety of effect images during a unit game. For example, on the upper liquid crystal panel 5A, a moving picture effect is performed when a winning is made, a moving picture effect such as a countdown is performed when a rescue pay function is executed, and the like.

The central variable display unit 4B is a rotating symbol display panel on which a player always fixes the eyes and has a transparent central liquid crystal panel 5B that is fixed to the front door of the cabinet 3. On the central liquid crystal panel 5B are displayed five display windows 151 to 155. Moreover, a payout-number display unit 8 and a credit-number display unit 9 are displayed in an upper part of the central liquid crystal panel 5B. The central liquid crystal panel 5B corresponds to the display 118 of FIG. 2.

The lower variable display unit 4C has a lower liquid crystal panel 5C that displays a point-number recorded in a card or a point-number of a game. A numerical value displayed on the lower liquid crystal panel 5C is based on a display result of the central variable display unit 4B. When a winning combination (internal winning combination) is made on the central variable display unit 4B, a point-number of a game displayed on the lower liquid crystal panel 5C is added on the basis of the winning combination made. A ticket printer 14 is provided to a left side of the lower liquid crystal panel 5C and a card reader 15 is provided to a right side of the lower liquid crystal panel 5C.

An operating table 10 that protrudes forward from the front face of the cabinet 3 is disposed below the lower variable display unit 4C. On the operating table 10, there are arranged operating buttons 11 (for example, BET button, collect button, start button and the like) as an operating unit enabling a player to operate a game. Furthermore, the operating table 10 is provided with a coin insertion slot 12, a coin insertion slot 90 for a rescue pay and a bill insertion slot 13. The operating buttons 11 correspond to the game start unit 119 of FIG. 2. In addition, the coin insertion slot 12 corresponds to the first game value insertion means 102 of FIG. 2 and the coin insertion slot 90 for a rescue pay corresponds to the second game value insertion means 106 of FIG. 2.

Through the coin insertion slot 12 and the coin insertion slot 90 for a rescue pay, which are provided to the operating table 10, a player can appropriately insert coins possessed into the coin insertion slot 12 and the coin insertion slot 90 for a rescue pay. The coin insertion slot 12 is used to insert a coin for a base game, which is inserted before a game is started. In addition, the coin for a base game inserted therefrom is transferred to a hopper 64 via a coin counter 59.

The coin insertion slot 90 for a rescue pay is used to insert the predetermined number of coins, for example two coins for a rescue pay. When a rescue pay function is not used, a player does not insert a coin therein and instead inserts a coin for a base game to start a game. The insertion of the two coins for a rescue pay is performed at a time when a coin for a base game can be inserted. When a coin for a rescue pay is inserted, the number of times that a “ready-to-win loss” is made in a predetermined unit game thereafter is counted in the ready-to-win loss counter 92. When it reaches a predetermined number of times (the “ready-to-win loss” of “HEART” is made eight times in this embodiment), 300 coins can be paid out. In the meantime, the coin for a rescue pay, which is inserted from the coin insertion slot 90 for a rescue pay, is transferred to the hopper 64 via the coin counter 93 for a rescue pay. Meanwhile, the ready-to-win loss counter 92 corresponds to the count means 113 of FIG. 2.

A waist-position panel 17 is disposed below the operating table 10. The waist-position panel 17 is a plastic panel having a game-related image printed thereto. The waist-position panel 17 is fixed to a lower front door 18 and illuminated by a cold cathode-ray tube. In addition, a coin receiving portion 19 that collects coins, which are paid out on the basis of a game result, is disposed below the waist-position panel 17.

Furthermore, a light-emitting unit 20 is disposed to the cabinet 3 of the slot machine 1 so that it surrounds a game area including the upper variable display unit 4A, the central variable display unit 4B, the lower variable display unit 4C and the operating table 10. The light-emitting unit 20 includes side lamps 22 that are provided to inclined parts 21, which are protruded in a bow shape at front right and left ends of the cabinet 3 and at side parts over the upper variable display unit 4A, the central variable display unit 4B and the lower variable display unit 4C, speaker lamps 24 that are provided to arc-shaped speakers 23, which are sideways protruded at the right and left ends of the cabinet 3 adjacent to the operating table 10, and are arranged along edges of the speakers 23, under lamps 25 that are provided to a lower front door 18 and arranged along lower edges of the waist-position panel 17, and top lamps 26 that are provided to an upper part of the upper variable display unit 4A and have power lamps 26a disposed at both sides and central band-shaped lamps 26b arranged in a horizontal direction.

(Electrical Structure of the Slot Machine 1: Main Control Board 71)

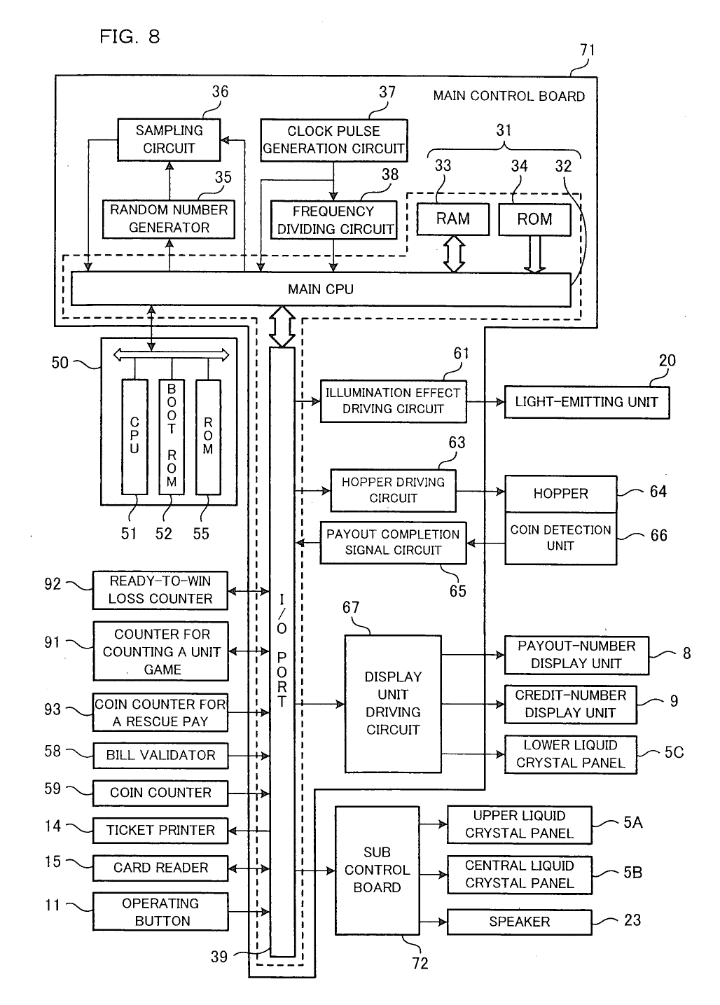

FIG. 8 is a block diagram showing an overall electrical structure of the slot machine 1. As shown in FIG. 8, the slot machine 1 includes many constitutional elements around a main control board 71 including a microcomputer 31. The main control board 71 includes a microcomputer 31, a random number generator 35, a sampling circuit 36, a clock pulse generating circuit 37, a frequency dividing circuit 38, an illumination effect driving circuit 61, a hopper driving circuit 63, a payout completion signal circuit 65 and a display unit driving circuit 67. The main control board 71 corresponds to the controller 101 of FIG. 2.

The microcomputer 31 has a main CPU 32, a RAM 33 and a ROM 34. The main CPU 32 operates in accordance with a program stored in the ROM 34 and executes an input/output of a signal to and from the other components through an I/O port 39, thereby controlling an overall operation of the slot machine 1. The microcomputer 31 corresponds to the game executing unit 103, the combination determining unit 104, the base payout award unit 105, the ready-to-win generating unit 110, the bonus game executing unit 107, the bonus game combination determining unit 108, the bonus game payout award unit 109, the ready-to-win loss determining unit 112, the special payout award unit 115 and the count determining unit 114 of FIG. 2.

The RAM 33 stores data, lottery tables such as a winning combination lottery table 130 for a base game, a winning combination lottery table 132 for a base game and the like, or programs such as a stop symbol determining program, a bonus game determining program, a bonus game stop symbol determining program and the like, which are used when the main CPU 32 operates. For example, after a game starts, the RAM 33 temporarily maintains a random number that is sampled by the sampling circuit 36, and stores code Nos. of a video reel that are displayed on the central liquid crystal panel 5B. In addition, the RAM 33 adds and stores the number of coins bet. Further, the RAM 33 adds and stores the number of coins paid out.

In addition, the ROM 34 stores programs of a game executing process, a bonus game process and the like that are executed by the main CPU 32 and permanent data of the slot machine 1. In addition, the ROM 34 stores a payout table 131 for a base game and a payout table 133 for a bonus game.

The random number generator 35 is operated in accordance with an instruction of the main CPU 32 and generates a random number within a predetermined range. The sampling circuit 36 samples any random number of the random numbers that are generated by the random number generator 35, in accordance with an instruction of the main CPU 32, and inputs the sampled random number into the main CPU 32. The sampled random number is used in a game executing process, a bonus game process and the like, which will be described later. The clock pulse generating circuit 37 generates a reference clock for operating the main CPU 32 and the frequency dividing circuit 38 inputs a signal that the reference clock is divided in a predetermined period to the main CPU 32.

Moreover, the main control board 71 is associated with the operating buttons 11 including a start button for inputting an instruction to start the scroll of the symbol columns, a collect button, a BET button and the like and allows signals corresponding to the push of the buttons to be inputted into the main CPU 32 via the I/O port 39.

In addition, the main control board 71 is associated with a gaming board 50. The gaming board 50 includes a CPU 51, a ROM 55 and a boot ROM 52, which are associated with each other through an internal bus. The CPU 51, the ROM 55 and the boot ROM 52, which are associated with each other through an internal bus, are associated with the main control board 71 through a PCI bus. The PCI bus transfers a signal between the main control board 71 and the gaming board 50 and supplies power to the gaming board 50 from the main control board 71. The ROM 55 stores an authentication program. The boot ROM 52 stores a preliminary authentication program and a program (boot code) enabling the CPU 51 to execute the preliminary authentication program.

The authentication program is a program (falsification check program) for authenticating a game program and a game system program. The authentication program is a program for confirming and verifying that the game program and the game system program are not falsified. In other words, the authentication program is described in accordance with a procedure for authenticating the game program and the game system program. The preliminary authentication program is a program for authenticating the authentication program. The preliminary authentication program is described in accordance with a procedure for verifying that the authentication to be authenticated is not falsified, i.e., for authenticating the authentication program.

In addition, the main control board 71 is associated with a bill validator 58, a coin counter 59, a ticket printer 14, a card reader 15, a coin counter 93 for a rescue pay, a counter 91 for counting a unit game and a ready-to-win loss counter 92.

The bill validator 58 reads out an image of bill inserted into the bill insertion slot 13 and receives the genuine bill in the cabinet 3. In addition, when receiving the genuine bill, the bill validator 58 outputs an input signal to the main CPU 32 based on an amount of the bill. The main CPU 32 stores a credit-number in the RAM 33, which corresponds to the amount of bill transmitted by the input signal.

The coin counter 59 is provided in the coin insertion slot 12, validates whether a coin, which is inserted in the coin insertion slot 12 by the player, is normal or not, and detects and counts a coin for a base game inserted from the coin insertion slot 12 one by one. A coin except the genuine coin is discharged to the coin receiving portion 19. In addition, the coin counter 59 outputs an input signal to the main CPU 41 when it detects a genuine coin.

The coin counter 93 for a rescue pay is provided in the coin insertion slot 90 for a rescue pay and validates whether a coin for a rescue pay, which is inserted into the coin insertion slot 90 for a rescue pay by a player, is normal or not. A coin except the genuine coin for a rescue pay is discharged to the coin receiving portion 19.

In addition, the coin counter 93 for a rescue pay detects and counts a coin for a rescue pay inserted from the coin insertion slot 90 for a rescue pay one by one. When a counted value reaches “2” in this embodiment, the coin counter 93 for a rescue pay generates a rescue pay signal (ON state). Thereby, a rescue pay period is started and a moving picture effect is executed on the upper liquid crystal panel 5A, which notifies a player that a rescue pay is executed. Meantime, a coin for a rescue pay, which is inserted extra after the rescue pay signal is generated (ON state), is cashed out to the coin receiving portion 19.

When a rescue pay signal is generated, the counter 91 for counting a unit game receives the counted value (“2” in this embodiment) from the coin counter 93 for a rescue pay whenever the unit game of one time is over, and integrates the counted value. In addition, the ready-to-win loss counter 92 is a counter that counts the “ready-to-win loss.”

The counted value of the coin counter 59 is cleared to “0” whenever the unit game of one time is over.

In addition, when a rescue pay signal is generated, the counted value (“2” in this embodiment) of the coin counter 93 for a rescue pay is transmitted to the counter 91 for counting a unit game. When the counted value of the counter 91 for counting a unit game reaches “20” in this embodiment, the rescue pay signal is stopped (rescue pay signal OFF state). Accordingly, the counter 91 for counting a unit game counts a rescue pay period (unit games of 10 times). The integrated value thereof is digital-displayed by the upper liquid crystal panel 5A.

In addition, the ready-to-win loss counter 92 has an initial value that is set as “8” in this embodiment. When a rescue pay signal is generated, the initial value is decreased by “1” whenever the symbols 180 are rearranged in a base game and a relation of the symbols 180 rearranged becomes a “ready-to-win loss state.” For example, when a “ready-to-win loss” is made under state that the ready-to-win loss counter 92 has a value of “8,” the ready-to-win loss counter 92 counts “7.”

When a value of the ready-to-win loss counter 92 reaches “0,” a rescue pay payout signal is generated. The rescue pay payout signal is supplied to a hopper driving circuit 63 to drive the hopper 64. The hopper 64 executes an operation of paying out 300 coins, thereby paying out the coins to the coin receiving portion 19.

When the 300 coins are completely paid out, the value of the ready-to-win loss counter 92 is cleared to “8.” Furthermore, when a bonus game trigger is made and when a combination of “HEART” is made, the value of the ready-to-win loss counter 92 is also cleared to “8” that is an initial value.

The ticket printer 14 prints a barcode on a ticket, in which data such as credit-number stored in the RAM 33, the day and time and identification number of the slot machine 1 is coded, based on the control signal outputted from the main CPU 32, and then outputs a ticket having the barcode attached thereto.

The card reader 15 reads the data from a smart card to transmit it to the main CPU 32, or writes the data to the smart card based on a control signal from the main CPU 32.

The illumination effect driving circuit 61 outputs an effect signal that causes the light-emitting unit 20 to execute an illumination effect. The light-emitting unit 20 consists of many lamps or LED including the side lamps 22, the speaker lamps 24, the under lamps 25 and the top lamps 26.

The hopper driving circuit 63 drives the hopper 64 under control of the main CPU 32. The hopper 64 executes an operation of paying out a coin and pays out the coin to the coin receiving portion 19. The payout completion signal circuit 65 inputs data of the coin-number from a coin detection unit 66 associated thereto and inputs a signal, which notifies payout completion of the coin when the coin-number reaches a predetermined number, to the main CPU 32. The coin detection unit 66 measures the number of coins paid out by the hopper 64 and inputs data of the measured number to the payout completion signal circuit 65. The display unit driving circuit 67 controls display operations of various display units such as the lower liquid crystal panel 5C.

(Electrical Structure of the Slot Machine: Sub Control Board 72)

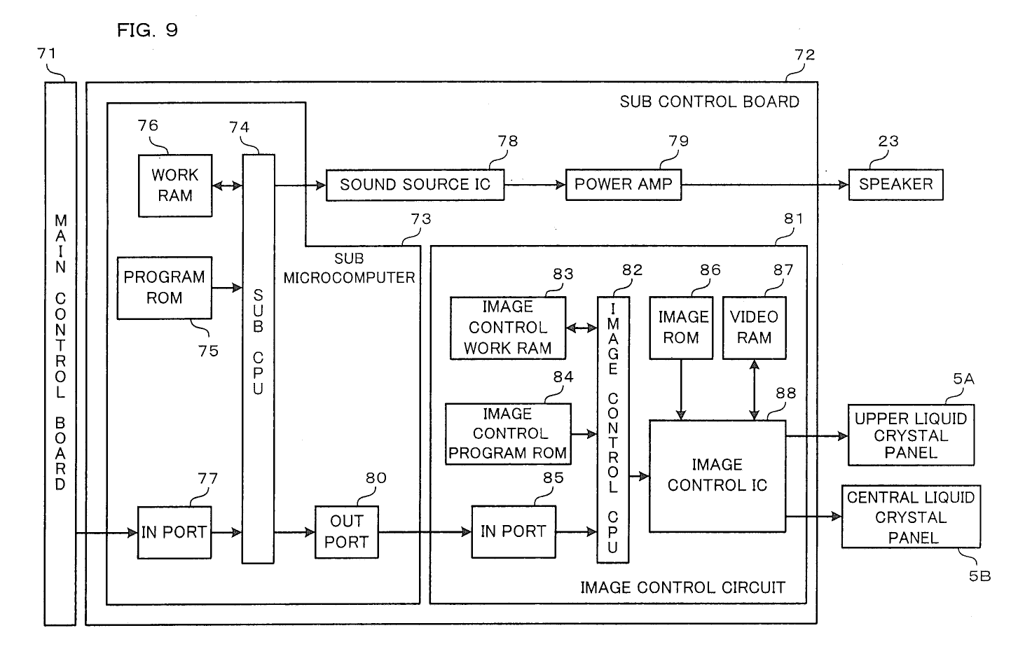

Further, the main control board 71 is associated with a sub control board 72. As shown in FIG. 9, the sub control board 72 performs a display control of the upper liquid crystal panel 5A of the upper variable display unit 4A, a display control of the central liquid crystal panel 5B of the central variable display unit 4B and an output control of a voice sound by the speakers 23, based on commands inputted from the main control board 71. The sub control board 72 is included on a circuit board different from the circuit board constituting the main control board 71 and has a microcomputer 73 (hereinafter, referred to as “sub microcomputer”) as a main component. In addition, the sub control board has a sound source IC 78 controlling a voice sound outputted from the speakers 23, a power AMP 79 serving as an amplifier and an image control circuit 81 serving as a display control means of the upper liquid crystal panel 5A and the central liquid crystal panel 5B.

The sub microcomputer 73 has a sub CPU 74 that performs a control operation in accordance with a control command transmitted from the main control board 71, a program ROM 75 serving as a memory means, a work RAM 76, an IN port 77 and an OUT port 80. Although the sub control board 72 does not have a clock pulse generating circuit, a frequency dividing circuit, a random number generator and a sampling circuit, it is structured to execute a random number sampling on the operating program of the sub CPU 74. The program ROM 75 stores a control program that is executed in the sub CPU 74. The work RAM 76 is structured to temporarily store work data or flag when the control program is executed in the sub CPU 74.

The image control circuit 81 has an image control CPU 82, an image control work RAM 83, an image control program ROM 84, an IN port 85, an image ROM 86, a video RAM 87 and an image control IC 88. The image control CPU 82 determines an image that is displayed on the upper liquid crystal panel 5A and the central liquid crystal panel 5B, in accordance with the image control program stored in the image control program ROM 84, based on a parameter that is set in the sub microcomputer 73.

The image control program ROM 84 stores an image control program that is related to a display on the upper liquid crystal panel 5A and the central liquid crystal panel 5B, or various selection tables. The image control work RAM 83 is configured to serve as a temporary memory means when the image control program is executed in the image control CPU 82. The image control IC 88 forms an image corresponding to the content determined in the image control CPU 82 and outputs it to the upper liquid crystal panel 5A and the central liquid crystal panel 5B.

The image ROM 86 stores dot data for forming an image. The video RAM 87 serves as a temporary memory means when an image is formed in the image control IC 88.

(Winning Combination Lottery Table for a Base Game)

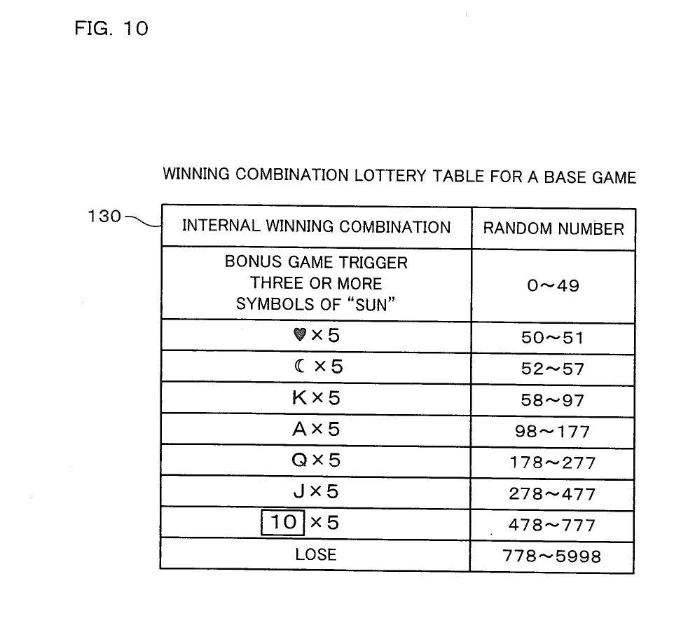

In the followings, a winning combination lottery table 130 for a base game, which is used in a base game, will be described with reference to FIG. 10. FIG. 10 illustrates a winning combination lottery table for a base game.

As shown in FIG. 10, a range of the random numbers, which are used in a winning combination lottery table 130 for a base game, is 0 to 5998. When the random number sampled through the sampling circuit 36 is 0 to 49, a bonus game is triggered. In this case, three or more symbols of “SUN” 181 are stopped in the display windows 151 to 155 at the same time and a gaming state is shifted to a bonus game. In addition, when the random number sampled through the sampling circuit 36 is 50 to 51, an internal winning combination of “HEART” 182 is determined. Then, five symbols of “HEART” 182 are stopped in the display windows 151 to 155. In addition, when the random number sampled through the sampling circuit 36 is 52 to 57, an internal winning combination of “MOON” 183 is determined. Then, five symbols of “MOON” 183 are stopped in the display windows 151 to 155. Likewise, when the random number is 58 to 97, an internal winning combination of “K” 186 is determined. When the random number is 98 to 177, an internal winning combination of “A” 184 is determined. When the random number is 178 to 277, an internal winning combination of “Q” 187 is determined. When the random number is 278 to 477, an internal winning combination of “J” 185 is determined. When the random number is 478 to 777, an internal winning combination of “10” 188 is determined. In addition, when the random number sampled through the sampling circuit 36 is 778 to 5998, a loss is determined, so that a combination of loss symbols is stopped in the display windows 151 to 155. Here, a state that the above internal winning combinations are determined means that a winning combination (internal winning combination) is made.

(Payout Table for a Base Game)

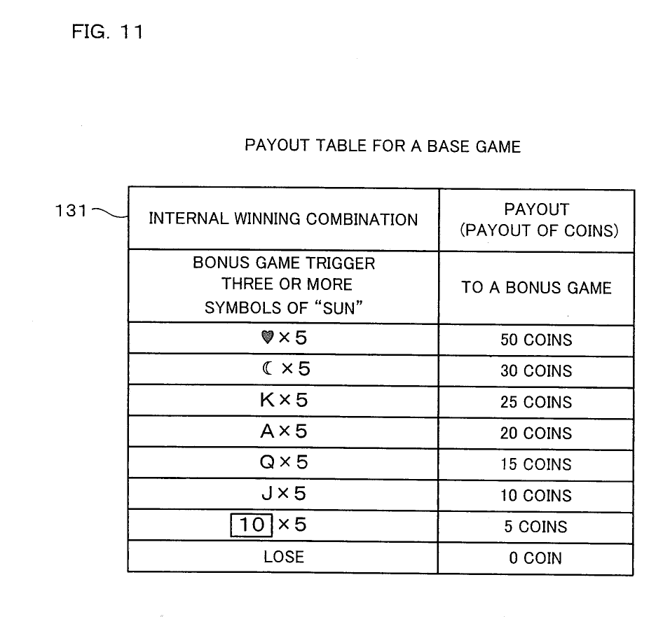

In the followings, based on FIG. 11, a payout table 131 for a base game will be described which shows a payout-number of coins relating to an internal winning combination determined in the winning combination lottery table 130 for a base game shown in FIG. 10. FIG. 11 shows a payout table for a base game.

Regarding a result sampled using the winning combination lottery table 130 for a base game, the coins relating to an internal winning combination displayed on the display windows 151 to 155 are paid out, based on the payout table 131 for a base game.

To be more specific, when three or more symbols of “SUN” 181 are stopped on the display windows 151 to 155 at the same time, a bonus game is given. In addition, when five symbols of “HEART” 182 are stopped on the display windows 151 to 155, 50 coins are paid out. When five symbols of “MOON” 183 are stopped on the display windows 151 to 155, 30 coins are paid out as a payout. Likewise, when five symbols of “K” 186 are stopped on the display windows 151 to 155, 25 coins are paid out as a payout. When five symbols of “A” 184 are stopped on the display windows 151 to 155, 20 coins are paid out as a payout. When five symbols of “Q” 187 are stopped on the display windows 151 to 155, 15 coins are paid out as a payout. When five symbols of “J” 185 are stopped on the display windows 151 to 155, 10 coins are paid out as a payout. When five symbols of “10” 188 are stopped on the display windows 151 to 155, 5 coins are paid out as a payout. In addition, when a lottery result is a loss and a combination of symbols of loss, which means any internal winning combination is not made, is stopped on the display windows 151 to 155, 0 (zero) coin is paid out as a payout.

(Winning Combination Lottery Table for a Bonus Game)

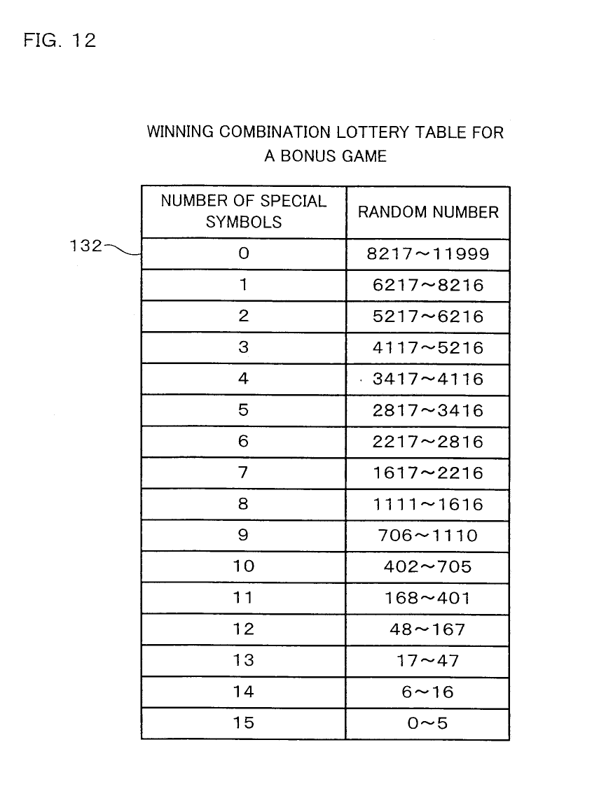

In the followings, a winning combination lottery table 132 for a bonus game, which is applied when a bonus game trigger is determined in the winning combination lottery table 130 for a base game, will be described with reference to FIG. 12. FIG. 12 shows a winning combination lottery table for a bonus game.

As shown in FIG. 12, a range of the random numbers, which are used in a winning combination lottery table 132 for a bonus game, is 0 to 11999. When the random number sampled through the sampling circuit 36 is 0 to 5, the special symbols 189 are stopped on the display windows 151 to 155 so that the sum total thereof is fifteen. In addition, when the random number sampled through the sampling circuit 36 is 6 to 16, the special symbols are stopped on the display windows 151 to 155 so that the sum total thereof is fourteen.

Likewise, when the random number is 17 to 47, the special symbols are stopped on the display windows 151 to 155 so that the sum total thereof is thirteen. When the random number is 48 to 167, the special symbols are stopped in the display windows 151 to 155 so that the sum total thereof is twelve. When the random number is 168 to 401, the special symbols are stopped on the display windows 151 to 155 so that the sum total thereof is eleven. When the random number is 402 to 705, the special symbols are stopped on the display windows 151 to 155 so that the sum total thereof is ten. When the random number is 706 to 1110, the special symbols are stopped on the display windows 151 to 155 so that the sum total thereof is nine. When the random number is 1111 to 1616, the special symbols are stopped on the display windows 151 to 155 so that the sum total thereof is eight. When the random number is 1617 to 2216, the special symbols are stopped on the display windows 151 to 155 so that the sum total thereof is seven. When the random number is 2217 to 2816, the special symbols are stopped on the display windows 151 to 155 so that the sum total thereof is six. When the random number is 2817 to 3416, the special symbols are stopped on the display windows 151 to 155 so that the sum total thereof is five. When the random number is 3417 to 4116, the special symbols are stopped on the display windows 151 to 155 so that the sum total thereof is four. When the random number is 4117 to 5216, the special symbols are stopped on the display windows 151 to 155 so that the sum total thereof is three. When the random number is 5217 to 6216, the special symbols are stopped on the display windows 151 to 155 so that the sum total thereof is two. When the random number is 6217 to 8216, the special symbols are stopped on the display windows 151 to 155 so that the sum total thereof is one. In addition, when the random number sampled through the sampling circuit 36 is 8217 to 11999, a loss is made and the special symbols are stopped on the display windows 151 to 155 so that the sum total thereof is zero.

(Payout Table for a Bonus Game)

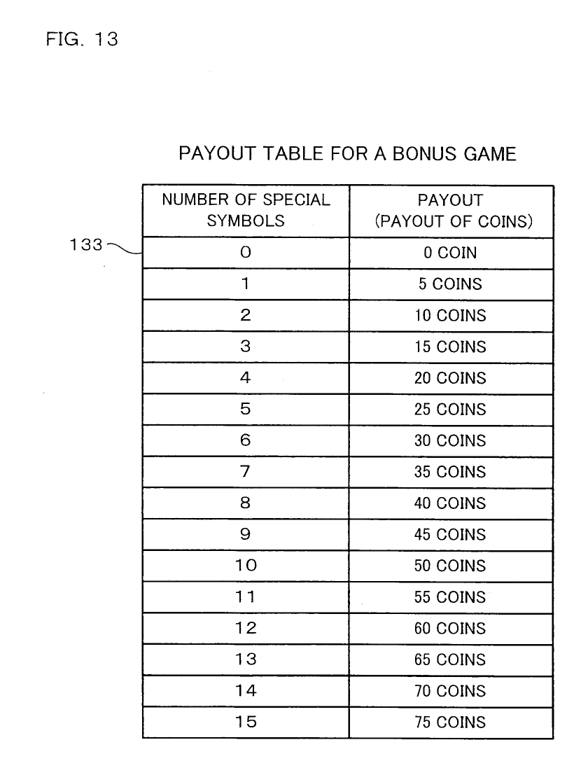

In the followings, a payout table 133 for a bonus game, which shows a payout-number of coins relating to the sum of the special symbols 189, will be described with reference to FIG. 13. FIG. 13 shows a payout table for a bonus game.

As a result of the sampling using the winning combination lottery table 132 for a bonus game shown in FIG. 12, the coins relating to the sum of the special symbols 189 displayed on the display windows 151 to 155 are paid out, based on the payout table 133 for a bonus game.

To be more specific, when the sum of the special symbols 189 is zero, no coin is paid out. When the sum of the special symbols 189 is one, five coins are paid out. When the sum of the special symbols 189 is two, ten coins are paid out. When the sum of the special symbols 189 is three, fifteen coins are paid out. Likewise, when the sum of the special symbols 189 is four, twenty coins are paid out. When the sum of the special symbols 189 is five, twenty-five coins are paid out. When the sum of the special symbols 189 is six, thirty coins are paid out. When the sum of the special symbols 189 is seven, thirty-five coins are paid out. When the sum of the special symbols 189 is eight, forty coins are paid out. When the sum of the special symbols 189 is nine, forty-five coins are paid out. When the sum of the special symbols 189 is ten, fifty coins are paid out. When the sum of the special symbols 189 is eleven, fifty-five coins are paid out. When the sum of the special symbols 189 is twelve, sixty coins are paid out. When the sum of the special symbols 189 is thirteen, sixty-five coins are paid out. When the sum of the special symbols 189 is fourteen, seventy coins are paid out. When the sum of the special symbols 189 is fifteen, seventy-five coins are paid out.

(Display State)

It will be specifically described an example of a display state of the central liquid crystal panel 5B serving as the display 118, with respect to the operation processes of the slot machine 1 and the playing method. In the meantime, as shown in FIGS. 4 to 6, the display state will be described with reference to a structure in which the central liquid crystal panel 5B arranges the symbols 180 in a video reel manner.

The central liquid crystal panel 5B has display windows 151 to 155 that arrange the symbols 180. The display windows 151 to 155 are arranged in a center of the central liquid crystal panel 5B. A symbol column consisting of the symbols 180 are scrolled in the display windows 151 to 155 (see FIG. 4). In addition, the respective display windows 151 to 155 are divided into upper stages 151a, 152a, 153a, 154a, 155a, central stages 151b, 152b, 153b, 154b, 155b and lower stages 151c, 152c, 153c, 154c, 155c. The symbols 180 are respectively stopped (arranged) in the respective stages 151a to 155a, 151b to 155b, 151c to 155c. For example, in FIG. 4, “SUN” 181 is stopped on the upper stage 151a of the display window 151, “J” 185 is stopped on the central stage 152b of the display window 152 and “Q” 187 is stopped on the lower stage 153c of the display window 153. Thereby, the display windows 151 to 155 display a symbol matrix consisting of five columns/three rows, as an arrangement area. In the meantime, the symbol matrix is not limited to five columns/three rows.

Furthermore, in a basic game (base game), when a predetermined number of symbols 181 to 188 referred to as scatter symbol are displayed as a winning combination on the central liquid crystal panel 5B, a process of awarding a payout, for example paying out coins is performed (the scatter symbol is such a symbol that if only a predetermined number of the scatter symbols are stopped on any one of the display areas of an arrangement area consisting of 5 columns/3 rows of the display windows 151 to 155, an effectiveness is made (for example, a payout is awarded, a bonus game is given, and the like)). For example, when three or more symbols of “SUN” 181, which is one of the scatter symbols shown in FIG. 4, are rearranged (displayed) on the central liquid crystal panel 5B, a gaming state is shifted to a bonus game, as a payout. In addition, when five or more symbols of “HEART” 182, which is one of the scatter symbols, are rearranged (displayed) on the central liquid crystal panel 5B, 50 coins are paid out, as a payout.

In the meantime, in this embodiment, the symbols 181 to 188 are set as the scatter symbols. However, the invention is not limited thereto. For example, a specific symbol only may be set as a scatter symbol. In addition, a scatter symbol may be chosen by a player. In addition, a payline L that horizontally traverses the central stages 151b to 155b of the respective display windows 151 to 155 may be provided. When the symbols stopped on the payline L constitute a predetermined combination, a process of paying out a coin may be performed. In other words, the payline L is provided to determine a combination of the symbols 180. When the symbols 180 are rearranged on and out of the payline L, a combination is determined for only the symbols 180 rearranged on the payline. As a result of the determination for a combination, when a winning combination is made, it is carried out, for example, a process of paying out a coin based on the winning combination.

(Display State at a Time When a Ready-to-Win Loss is Made)

FIG. 4 shows a case where the symbols 180 are rearranged in a basic game (base game) and a relation of the symbols 180 rearranged includes a relation of a “ready-to-win loss.” To be more specific, FIG. 4 shows a state that four symbols of “HEART” 182 are rearranged on the display windows 151 to 155 of the central liquid crystal panel 5B. For example, as shown in FIG. 4, an image is displayed in which a base game is executed and the symbols 180 are sequentially rearranged on the display windows 151 to 155. Then, when all the symbols 180 are rearranged via a “ready-to-win state,” a state is shown in which four symbols of “HEART” 182 are stopped on the display windows 151 to 155 (a state that a ready-to-win loss of “HEART” 182 is made).

In addition, when a base game is executed on the central liquid crystal panel 5B and the symbols 180 are sequentially rearranged on the display windows 151 to 155, a value of the ready-to-win loss counter 92 is displayed on the upper liquid crystal panel 5A, as shown in FIG. 4. For example, a state is shown in which a ready-to-win loss of “HEART” is made four times of eight times. Then, when a ready-to-win loss of “HEART” 182 is made on the central liquid crystal panel 5B, the value of the ready-to-win loss counter 92 is subtracted by “1” and displayed on the upper liquid crystal panel 5A. To be more specific, the value is decreased to “3/8” from “4/8” and displayed.

(Display State at a Time When an Internal Winning Combination is Made)

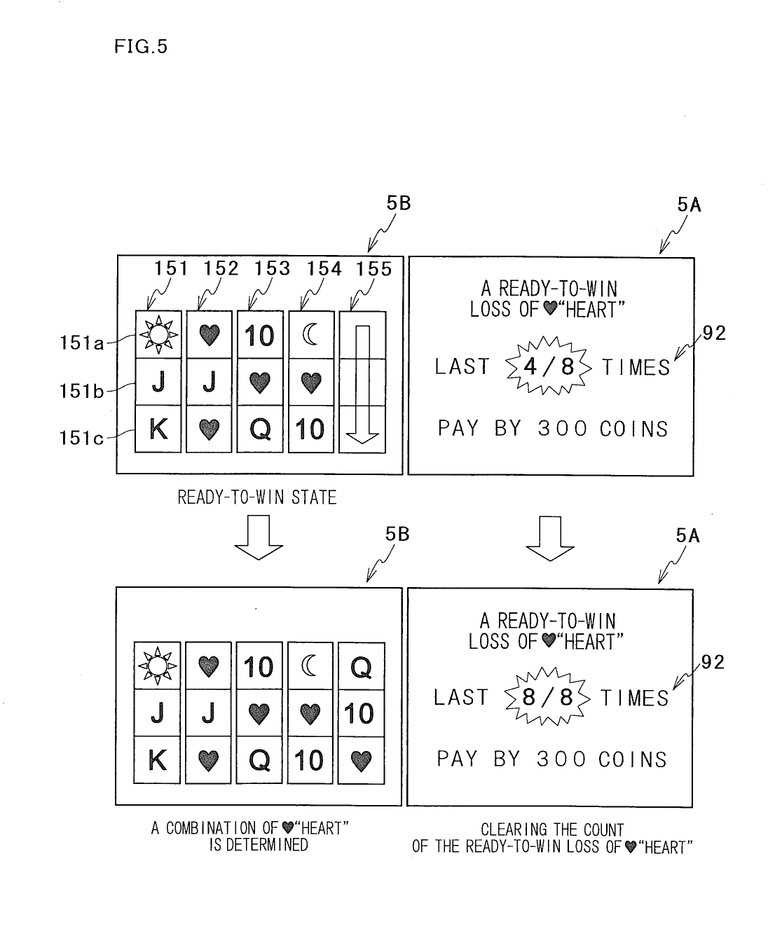

FIG. 5 shows a case where the symbols 180 are rearranged in a basic game (base game) and a relation of the symbols 180 rearranged includes a relation of an establishment of an internal winning combination. To be more specific, FIG. 5 shows a state that five symbols of “HEART” 182 are displayed on the display windows 151 to 155 of the central liquid crystal panel 5B. For example, as shown in FIG. 5, an image is shown in which a base game is executed and the symbols 180 are sequentially rearranged on the display windows 151 to 155. Then, when all the symbols 180 are rearranged via a “ready-to-win state,” a state is shown in which five symbols of “HEART” 182 are stopped on the display windows 151 to 155 (a state that an internal winning combination of “HEART” 182 is made).

In addition, when a base game is executed on the central liquid crystal panel 5B and the symbols 180 are sequentially rearranged on the display windows 151 to 155, a value of the ready-to-win loss counter 92 is displayed on the upper liquid crystal panel 5A, as shown in FIG. 5. For example, a state is shown in which a ready-to-win loss of “HEART” is made four times of eight times. Then, when an internal winning combination of “HEART” 182 is made on the central liquid crystal panel 5B, the value of the ready-to-win loss counter 92 is cleared and displayed on the upper liquid crystal panel 5A. To be more specific, the value is cleared to “8/8” from “4/8” and displayed.

(Display State at a Time When a Bonus Game is Executed)

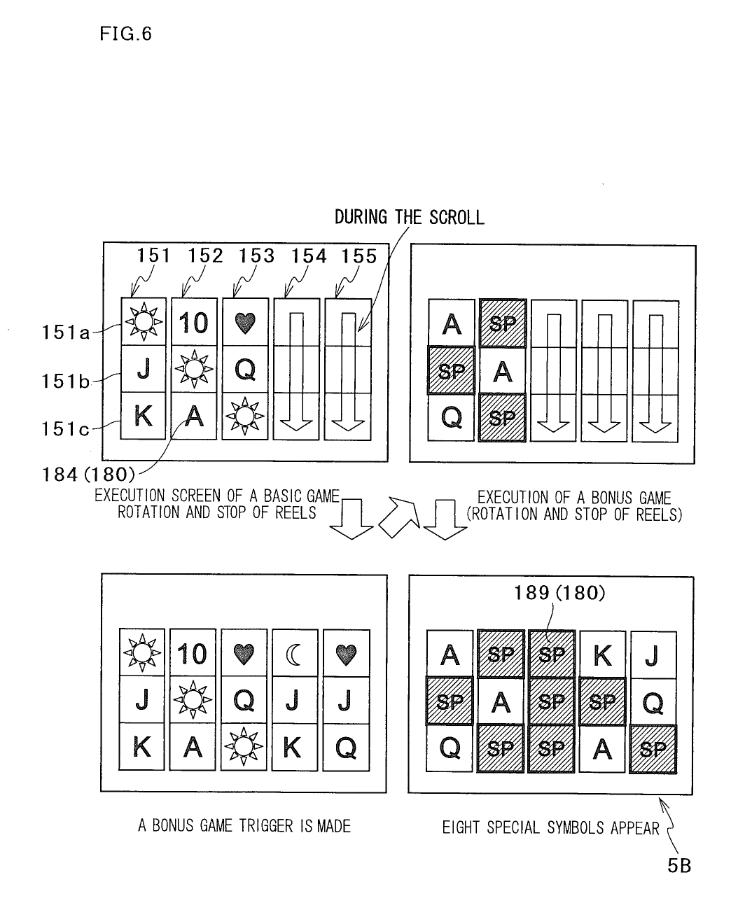

FIG. 6 shows a state of a rearrangement of the symbols 180 as a bonus game that is executed when the symbols 180 are rearranged in a basic game (base game) and a relation of the symbols 180 rearranged includes a relation of a bonus game trigger (a state that three symbols of “SUN” 181 are rearranged, in this embodiment). For example, as shown in FIG. 6, an image is shown in which a base game is executed and the symbols 180 are sequentially rearranged on the display windows 151 to 155. In addition, a state is shown which a bonus game trigger is made in which three symbols of “SUN” 181 are rearranged. Then, an image is shown in which a bonus game is executed and the symbols 180 are sequentially rearranged on the display windows 151 to 155. Then, when all the symbols 180 are rearranged, eight symbols of “SP,” which is a special symbol 189, are stopped on the display windows 151 to 155. Meantime, in this embodiment, when the bonus game is over, the value of the ready-to-win loss counter 92 is cleared and displayed on the upper liquid crystal panel 5A.

(Symbol, Combination and the Like)

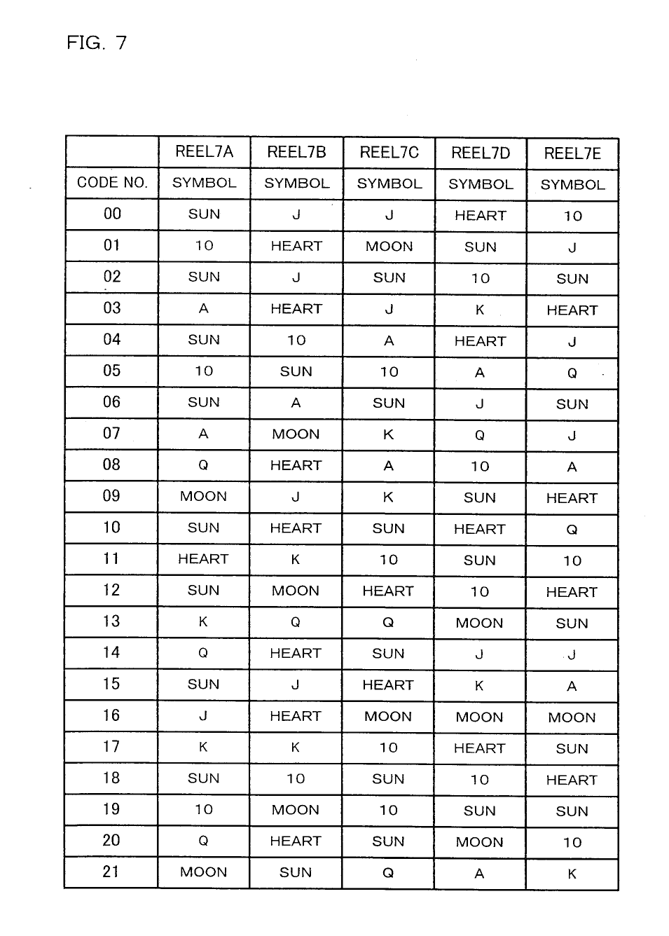

As shown in FIG. 7, the symbols 180 to be displayed on the display windows 151 to 155 of the central liquid crystal panel 5B constitute the symbol columns by twenty-two symbols. The symbols constituting the respective symbol columns are given with one code number of 0 to 21. Each of the symbol columns is constituted with a combination of symbols of the picture symbols “SUN” 181, “HEART” 182 and “MOON” 183, and the letter symbols of “A” 184, “J” 185, “K” 186, “Q” 187 and “10” 188.

The three successive symbols in the symbol columns are displayed (arranged) on the upper stages 151a, 152a, 153a, 154a, 155a, the center stages 151b, 152b, 153b, 154b, 155b and the lower stages 151c, 152c, 153c, 154c, 155c, respectively, so that they constitute a symbol matrix of five columns/three rows in the display windows 151 to 155. When a BET button is pushed and then a start button is pushed to start a game, the symbol columns constituting the symbol matrix are scrolled. When a predetermined time period has elapsed after the scroll, each scroll of the symbols is stopped (rearranged).

In addition, the symbols 181 to 188 are set as the scatter symbols. The scatter symbol is a symbol that makes an advantageous state to a player when a predetermined number of the scatter symbols are displayed on the display windows 151 to 155. The advantageous state is a state in which a coin is paid out in accordance with the scatter symbols, a state in which the payout-number of coins is added to a credit, a state in which a bonus game is started, and the like.

For example, when three or more symbols of “SUN” 181 are rearranged on the display windows 151 to 155, a bonus game is triggered and a gaming state is shifted to a bonus game from a base game (basic game). In addition, when five or more symbols of “MOON” 183 are stopped on the display windows 151 to 155, 30 coins (game medium) are paid out per one bet.

In the meantime, the bonus game is a gaming state that is more advantageous than a basic game. In this embodiment, the bonus game is a free game. The free game is a gaming state allowing a player to play a game for a predetermined number of times, without betting a coin. The bonus game is not particularly limited as long as it is a gaming state advantageous to the player, i.e., it is more advantageous than the basic game. For example, the bonus game may include a state in which it is possible to obtain more game media than the basic game, a state in which it is possible to obtain a game medium in a higher probability than in the basic game, a state in which a game medium is less consumed than in the basic game, and the like. Specifically, a free game, a second game, a feature game and the like are examples of the bonus game.

(Processing Operations of the Slot Machine 1: Main Control Board 71)

In the followings, the processes, which are carried out in the main control board 71 of the slot machine 1, will be described. When the main CPU 32 reads out and executes a program stored in the ROM 34, a game is progressed.

(Initial Process)

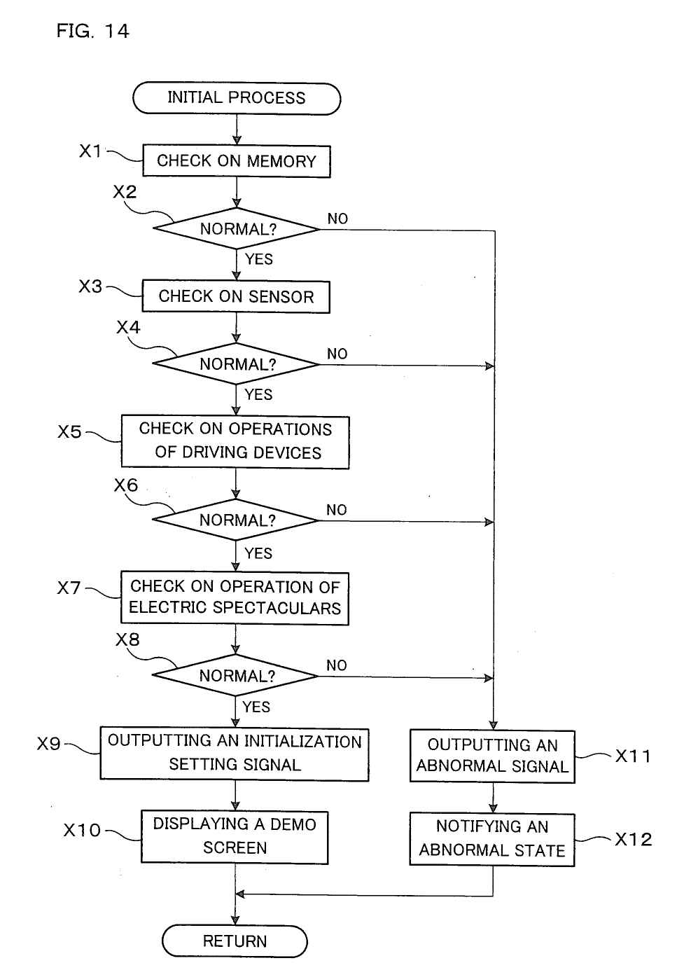

Firstly, an initial process as a starting process that is executed when the power of the slot machine 1 is ON will be described with reference to FIG. 14. FIG. 14 is a flow chart showing an initial process. The initial process is a process that is executed by the main control board 71 and the gaming board 50.

First, when power is supplied in a power unit (not shown), the main control board 71 and the gaming board 50 are started. When the main control board 71 and the gaming board 50 are started, separate processes are carried out in parallel, respectively. In other words, in the gaming board 50, the CPU 51 reads out the preliminary authentication program stored in the boot ROM 52 and performs a preliminary authentication of confirming and verifying in advance that the authentication program is not falsified before it is loaded to the main control board 71. In the meantime, in the main control board 71, the main CPU 32 executes the BIOS stored in the ROM 34 and develops the compressed data, which is incorporated in the BIOS, into the RAM 33. Then, the main CPU 32 executes the BIOS developed into the RAM 33 to check and initialize the operations of the various peripheral devices.

To be more specific, a check on an operation of a memory such as RAM 33 is executed (X1) to determine whether the operation is normal or not (X2). When the operation is not normal (X2, NO), an abnormal signal is outputted (X11). In the meantime, when the operation is normal (X2, YES), a check on the operations of the various sensors (for example, bill validator 58, coin counter 59 and the like) is continuously executed (X3) to determine whether the operations are normal or not (X4). When the operations are not normal (X4, NO), an abnormal signal is outputted (X11). Meanwhile, when the operations are normal (X4, YES), a check on the operations of the driving devices (for example, illumination effect driving circuit 61, hopper driving circuit 63, display unit driving circuit 67 and the like) is continuously executed (X5) to determine whether the operations are normal or not (X6). When the operations are not normal (X6, NO), an abnormal signal is outputted (X11). Meanwhile, when the operations are normal (X6, YES), a check on an operation of the electric spectaculars is continuously executed (X7) to determine whether the operation is normal or not (X8). When the operation is not normal (X8, NO), an abnormal signal is outputted (X11). In the meantime, when the operation is normal (X11, YES), an initialization setting signal to instruct an initialization of the various peripheral devices is outputted (X9).

Then, a demo screen is displayed on the central liquid crystal panel 5B, which notifies that the check on the operations of the various peripheral devices and the initialization setting thereof are completed (X10). Meanwhile, in the step of X11, when an abnormal signal is outputted, a demo screen is displayed which notifies an abnormal state of the peripheral devices (X12).

In addition, the main CPU 32 is associated with the ROM 55 of the gaming board 50 via the PCI bus. Accordingly, the main CPU 32 reads out the authentication program stored in the ROM 55 and stores the authentication program read in the RAM 33. At this time, the main CPU 32 takes a check sum by an ADDSUM manner (standard check function) in accordance with a standard BIOS function of the BIOS and stores the authentication program in the RAM 33.

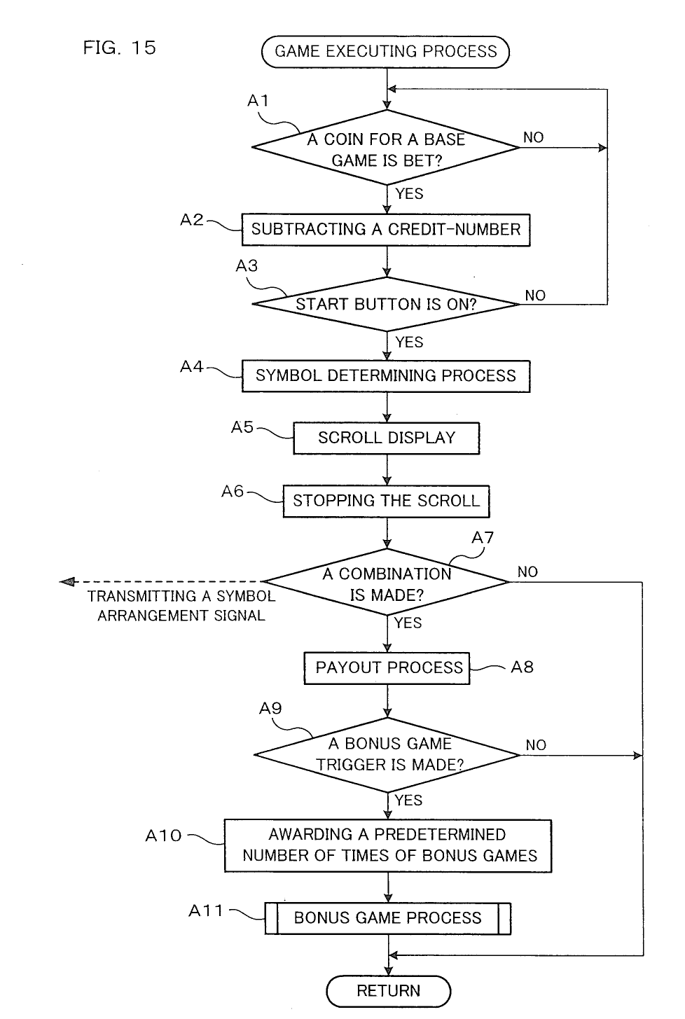

After the above processes, the main CPU 32 sequentially reads out and executes the game program and the game system program, thereby carrying out a game executing program shown in FIG. 15.

(Game Executing Process)

The main CPU 32 of the slot machine 1 carries out a game executing process shown in FIG. 15. When the game executing process is carried out, the main CPU 32 determines whether a coin for a base game is bet or not (A1). In this process, it is determined whether an input signal due to a push of the Bet button is received or not. When it is determined that a coin for a base game is not bet (A1, NO), the step of A1 is re-executed, so that the main CPU waits until a coin for a base game is bet.

In the meantime, when it is determined that a coin for a base game is bet (A1, YES), the credit-number stored in the RAM 33 is subtracted in accordance with the number of coins for a base game bet (A2). Meanwhile, when the number of coins for a base game bet is greater than the credit-number stored in the RAM 33, the step of A2 is re-executed without subtracting the credit-number. In addition, when the number of coins for a base game bet exceeds the upper limit (in this embodiment, fifty pieces) allowing a player to bet a coin in a single game, a step of A3 is executed without subtracting the credit-number.

Next, it is determined whether a start button is ON or not (A3). When it is determined that the start button is not ON (A3, NO), the process is returned to the step of A1. Meanwhile, when it is determined that the start button is not ON (for example, the start button is not ON and an instruction to end the game is inputted), it is canceled the subtraction result in the step of A2.

In the meantime, when it is determined that the start button is ON (A3, YES), a symbol determining process is executed (A4). In other words, a stop symbol determining program is executed, based on the winning combination lottery table 130 for a base game stored in the RAM 33, so that a symbol matrix including the fifteen symbols 180 to be stopped is determined.

Then, the symbols 180 of the display windows 151 to 155 are scrolled (A5). After a predetermined time (base time) has elapsed since the scroll of the symbols 180 is started, the symbol matrix determined in the step of A4 is stopped (rearranged) in the display windows 151 to 155 (A6).

Then, it is determined whether a combination is made, i.e., a combination of the symbols 180 stopped on the display windows 151 to 155 is a winning combination (A7). Meantime, information of an arrangement of the symbols stopped on the display windows 151 to 155 is transmitted as a symbol arrangement signal. When a combination is not a winning combination (a winning combination means that a combination is made) (A7, NO), this process is ended. Meanwhile, when a combination is a winning combination (A7, YES), a payout process is executed (A8). In other words, it is calculated a payout-number of coins, based on the realization of a winning combination that is an internal winning combination shown in FIG. 11. When the coins to be paid out are stored, a predetermined number of credits are added to the credit-number stored in the RAM 33. In the meantime, when the coins are paid out, a control signal is transmitted to the hopper 64, so that a predetermined number of coins are paid out to the coin receiving portion 19.

Then, it is determined whether a bonus game trigger is made as a winning combination (A9). In other words, it is determined whether three or more symbols of “SUN” 181 are arranged on the display windows 151 to 155. When it is determined that a bonus game trigger is not made (A9, NO), this process is ended. In the meantime, when it is determined that a bonus game trigger is made (A9, YES), a gaming state is shifted to a bonus game from a base game (basic game). In other words, a bonus game is awarded in which a game can be performed over the predetermined number of times (in this embodiment, 10 times) without betting a coin (A10). Then, a bonus game process is executed (A11). The bonus game process will be described later. Then, this process is ended.

(Bonus Game Process)

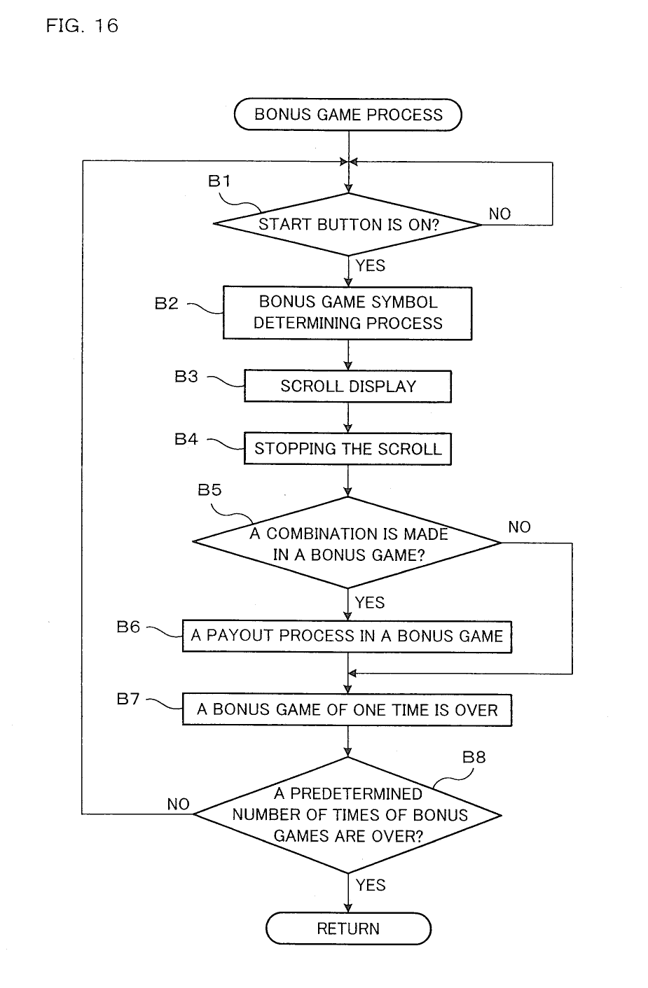

When it is determined in the step of A9 of FIG. 15 that a bonus game trigger is made, the main CPU 32 of the slot machine 1 executes a bonus game process shown in FIG. 16 in a step of A11. The bonus game process program is stored in the ROM 34.

When the bonus game process is executed, it is determined whether a start button is ON (B1). When it is determined that a start button is not ON (B1, NO), the process is returned to the step of B1.

In the meantime, when it is determined that a start button is ON (B1, YES), a bonus game symbol determining process is executed (B2). In other words, a bonus game stop symbol determining program is executed based on the winning combination lottery table 132 for a bonus game stored in the RAM 33, so that a symbol matrix including the fifteen symbols 180 to be stopped is determined.

Then, the symbols 180 of the display windows 151 to 155 are scrolled (B3). After a predetermined time (base time) has elapsed since the scroll of the symbols 180 is started, the symbol matrix determined in the step of B2 is stopped (rearranged) on the display windows 151 to 155 (B4).

Then, it is determined whether a combination is made in a bonus game, i.e., a special symbol 189 is included in the symbol matrix stopped (B5). When it is determined that there is no special symbol 189 (B5, NO), the process is shifted to a step of B7. In the meantime, when it is determined that there is a special symbol 189 (B5, YES), a payout process, which pays out coins corresponding to the number of the special symbols 189 displayed on the display windows 151 to 155, is executed based on the payout table 133 for a bonus game (B6). In other words, as shown in FIG. 13, a payout-number of coins based on the number of the special symbols 189 is calculated. When the coins to be paid out are stored, a predetermined number of credits are added to the credit-number stored in the RAM 33. In the meantime, when the coins are paid out, a control signal is transmitted to the hopper 64, so that a predetermined number of coins are paid out to the coin receiving portion 19. Thereby, the bonus game of one time is over (B7). In other words, among the predetermined number of times (in this embodiment, 10 times) of the bonus games provided by the step of A10 of the game executing process shown in FIG. 15, the bonus game of one time is over.

Then, it is determined whether the predetermined number of times (in this embodiment, 10 times) of the bonus games provided by the step of A10 of the game executing process shown in FIG. 15 are over (B8). Specifically, it is determined whether the bonus games of ten times are over. When it is determined that the predetermined number of times of the bonus games are not over (B8, NO), the process is returned to the step of B1. In the meantime, when it is determined that the predetermined number of times of the bonus games are over (B8, YES), this process is ended.

(Rescue Pay Executing Process)

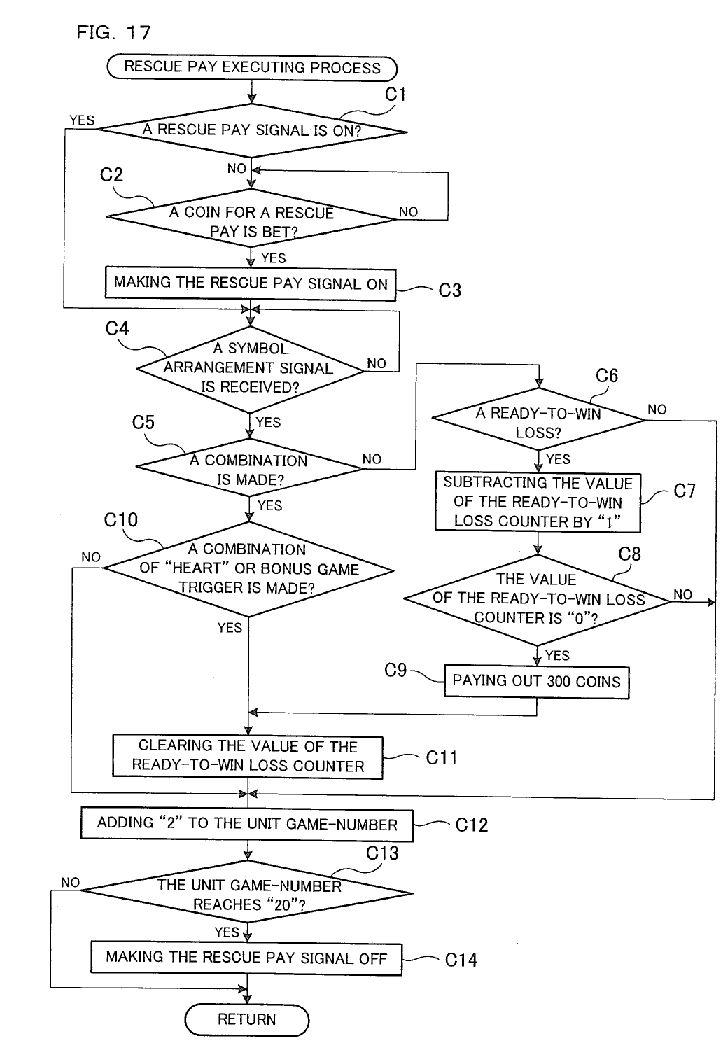

When a coin for a rescue pay is inserted into the coin insertion slot 90 for a rescue pay, the main CPU 32 of the slot machine 1 executes a rescue pay executing process shown in FIG. 17. The rescue pay executing process program is stored in the ROM 34.

When the rescue pay executing process is executed, it is first determined whether a rescue pay signal, which notifies whether it is a rescue pay period or not, is generated (ON state) (C1). When it is determined that a rescue pay signal is generated (ON) (C1, YES), the process is shifted to a step of C4. Meantime, when it is determined that a rescue pay signal is not generated (ON) (C1, NO), a coin for a rescue pay is inserted into the coin insertion slot 90 for a rescue pay and it is determined whether a value of “2” is counted in the coin counter 93 for a rescue pay (C2). When a value of “2” is not counted in the coin counter 93 for a rescue pay (C2, NO), the main CPU waits that a coin for a rescue pay is inserted into the coin insertion slot 90 for a rescue pay. Meanwhile, when a value of “2” is counted in the coin counter 93 for a rescue pay (C2, YES), a rescue pay signal is generated (ON) (C3).

Then, it is determined whether the symbol arrangement signal transmitted in the step of A7 of the game executing process is received or not (C4). When the symbol arrangement signal is not received (C4, NO), a waiting state of receiving the symbol arrangement signal is made. In the meantime, when the symbol arrangement signal is received (C4, YES), it is determined on the basis of the arrangement information of the symbols stopped on the display windows 151 to 155 whether a combination is made, i.e., a combination of the symbols 180 stopped on the display windows 151 to 155 is a winning combination (C5) When it is determined that the combination is a winning combination (C5, YES), it is determined whether a combination of “HEART” is made (a state that five symbols of “HEART” 182 are displayed) or a bonus game trigger (a state that three symbols of “SUN” are displayed) is made (C10). When a combination of “HEART” or a bonus game trigger is not made (C10, NO), the process is shifted to a step of C12. Meanwhile, when a combination of “HEART” or a bonus game trigger is made (C10, YES), the value of the ready-to-win loss counter 92 is cleared to “8” that is an initial value (C11). Then, the process is shifted to a step of C12.

Meanwhile, in this embodiment, when a bonus game trigger is made, the value of the ready-to-win loss counter 92 is cleared to “8” that is an initial value. However, it may be possible that when a predetermined time period has elapsed, the value of the ready-to-win loss counter 92 is cleared to an initial value, or when a predetermined number of times of the unit games are executed, the value of the ready-to-win loss counter 92 is cleared to an initial value.

In the meantime, when it is determined that the combination is not a winning combination (C5, NO), it is determined whether an arrangement of the symbols stopped on the display windows 151 to 155 is a “ready-to-win loss” or not (C6). In this embodiment, it is determined whether the arrangement is a ready-to-win loss of “HEART” (a state that four symbols of “HEART” 182 are displayed). When the arrangement is not a “ready-to-won loss” (C6, NO), the process is shifted to a step of C12. In the meantime, when the arrangement is a “ready-to-won loss” (C6, YES), the value of the ready-to-win loss counter 92 is subtracted by “1” (C7).

Then, it is determined whether the value of the ready-to-win loss counter 92 is “0” or not (C8). When the value of the ready-to-win loss counter 92 is not “0” (C8, NO), the process is shifted to a step of C12. Meanwhile, when the value of the ready-to-win loss counter 92 is “0” (C8, YES), a rescue pay payout signal is supplied to the hopper driving circuit 63 to drive the hopper 64 that then pays out the 300 (three hundreds) coins (C9). Then, after the 300 coins are paid out, the value of the ready-to-win loss counter 92 is cleared to “8” (C11). Then, the process is shifted to a step of C12.

Then, the counter 91 for counting a unit game receives the counted value (“2” in this embodiment) from the coin counter 93 for a rescue pay and integrates the counted value (C12). Then, it is determined whether the counted value of the counter 91 for counting a unit game, which is integrated in the step of C12, reaches “20” in this embodiment (C13). When the counted value of the counter 91 for counting a unit game does not reach “20” (C13, NO), this process is ended. Meanwhile, when the counted value of the counter 91 for counting a unit game reaches “20” (C13, YES), the rescue pay signal is stopped (C14). In other words, the rescue pay signal is made OFF (OFF state). Thereby, this process is ended.

According to the above structure, in the slot machine 1 having the scatter symbols, a step (“ready-to-win state”) is generated in which there is a possibility that a predetermined number of scatter symbols are rearranged due to a relation between scatter symbols of an area already rearranged and scatter symbols to be rearranged in any one rearrangement area (display windows 151 to 155), before the scatter symbols are rearranged in that area. Then, when a predetermined number of scatter symbols are not rearranged (ready-to-win loss), a value of the ready-to-win loss counter 92 is counted. When the value of the ready-to-win loss counter 92 reaches a predetermined value (“eight times” in this embodiment), a special payout (300 coins) can be awarded. Thereby, even when a predetermined number of scatter symbols are not rearranged (ready-to-win loss state), a player may have an expectation for a special payout. In addition, since it is conditioned that a step is generated in which there is a possibility that a predetermined number of scatter symbols are rearranged due to a relation between scatter symbols of an area already rearranged and scatter symbols to be rearranged in any one rearrangement area, before the scatter symbols are rearranged in that area, so as to obtain a special payout (a ready-to-win state is conditioned), the frequency to be counted is decreased. Thereby, a predetermined value of the count is set low, so that a player may feel closer to an expectation that a special payout will be awarded and maintain an expectation for the special payout, as compared to a case where a predetermined value of the count is set high.

In addition, the value counted in the ready-to-win loss counter 92 can be reset by a predetermined condition. Thereby, when the value counted in the ready-to-win loss counter 92 is reset on condition that a bonus game is generated, a special payout is not obtained and a payout by the bonus game can be instead obtained. Accordingly, it may be possible that a game is continued without deteriorating a sense of satisfaction of a player.

In addition, the value of the ready-to-win loss counter 92 can be counted only when a coin for a rescue pay is inserted into the coin insertion slot 90 for a rescue pay. Thereby, a player can freely select whether to obtain a chance that a special payout will be awarded.

(Processing Operations of the Slot Machine 1: Sub Control Board 72)

When the various processes are executed by the initial process, the game executing process, the bonus game process or the rescue pay executing process in the main control board 71, the results or contents due to the processes are inputted as commands or data into the sub control board 72. The sub control board 72 performs the display of the payout-number display unit 9, the credit-number display unit 9 and the like of the central liquid crystal panel 5B and displays an effect image in the upper liquid crystal panel 5A. In addition, the sub control board 72 performs an effect by a sound output from the speakers 23 in accordance with an effect on the upper liquid crystal panel 5A or independently.

Although the above descriptions have been provided with regard to the characteristic parts so as to understand the invention more easily, the invention is not limited to the embodiment as described above and can be applied to the other embodiments and the applicable scope should be construed as broadly as possible. Furthermore, the terms and phraseology used in the specification have been used to correctly illustrate the invention, not to limit it. In addition, it will be understood by those skilled in the art that the other structures, systems, methods and the like included in the spirit of the invention can be easily derived from the spirit of the invention described in the specification. Accordingly, it should be considered that the invention covers equivalent structures thereof without departing from the spirit and scope of the invention as defined in the following claims. Further, the abstract is provided so that an intellectual property office and a general public institution or one skilled in the art who is not familiar with patent and legal or professional terminology can quickly analyze the technical features and essences of the invention through a simple investigation. Accordingly, the abstract is not intended to limit the scope of the invention that should be evaluated by the claims. In addition, it is required to sufficiently refer to the documents that have been already disclosed, so as to fully understand the objects and effects of the invention.

The above descriptions include a process that is executed on a computer or computer network. The above descriptions and expressions have been provided so that the one skilled in the art can understand the invention most effectively. In the specification, the respective steps used to induce one result or blocks having a predetermined processing function should be understood as a process having no self-contradiction. In addition, the electrical or magnetic signal is transmitted/received and written in the respective steps or blocks. Although the processes in the respective steps or blocks embody the signal as a bit, value, symbol character, term, number and the like, it should be noted that these have been used for the convenience of descriptions. Further, although the processes in the respective steps or blocks have been often described as an expression common to a human action, the process described in the specification is executed by a variety of devices in principle. In addition, the other structures necessary for the respective steps or blocks are apparent from the above descriptions.

What is claimed is:

1. A gaming machine comprising:
a display that has an arrangement area of a matrix type and arranges a plurality of symbols in the arrangement area;
a game value insertion means that inserts a game value;
a count means that calculates a count; and
a controller that operates:
(a1) to rearrange the symbols so that a timing at which the symbols are rearranged in at least one arrangement area is different from a timing at which the symbols are rearranged in another arrangement area, after a game value is inserted;
(a2) to generate a step in which there is a possibility that a predetermined combination is generated due to a relation between symbols of an area already rearranged and symbols to be rearranged in any one rearrangement area, before the symbols are rearranged in that area;
(a3) to award a base payout, when the predetermined combination is generated by the symbols rearranged;
(a4) to calculate the count, when the predetermined combination is not generated by the symbols rearranged; and
(a5) to award a special payout, when the count reaches a predetermined value.

2. The gaming machine according to claim 1, wherein the controller resets the value counted in the count means by a predetermined condition.

3. A gaming machine comprising:
a display that has an arrangement area of a matrix type and at least one payline and arranges a plurality of symbols in the arrangement area;
a game value insertion means that inserts a game value;
a count means that calculates a count; and
a controller that operates:
(b1) to rearrange the symbols so that a timing at which the symbols are rearranged in at least one arrangement area is different from a timing at which the symbols are rearranged in another arrangement area, after a game value is inserted;
(b2) to generate a step in which there is a possibility that a predetermined combination is generated on the payline due to a relation between symbols of an area already rearranged and symbols to be rearranged in any one rearrangement area, before the symbols are rearranged in that area;
(b3) to award a base payout, when the predetermined combination is generated on the payline by the symbols rearranged;
(b4) to calculate the count, when the predetermined combination is not generated on the payline by the symbols rearranged; and
(b5) to award a special payout, when the count reaches a predetermined value.

4. The gaming machine according to claim 3, wherein the controller resets the value counted in the count means by a predetermined condition.

5. A gaming machine comprising:
a display that has an arrangement area of a matrix type and arranges a plurality of scatter symbols in the arrangement area;
a game value insertion means that inserts a game value;
a count means that calculates a count; and
a controller that operates:
(c1) to rearrange the scatter symbols so that a timing at which the symbols are rearranged in at least one arrangement area is different from a timing at which the symbols are rearranged in another arrangement area, after a game value is inserted;
(c2) to generate a step in which there is a possibility that a predetermined number of scatter symbols are rearranged due to a relation between scatter symbols of an area already rearranged and scatter symbols to be rearranged in any one rearrangement area, before the scatter symbols are rearranged in that area;
(c3) to award a base payout, when the predetermined number of scatter symbols are rearranged by the scatter symbols rearranged;
(c4) to calculate the count, when the predetermined number of scatter symbols are not rearranged by the scatter symbols rearranged; and
(c5) to award a special payout, when the count reaches a predetermined value.

6. The gaming machine according to claim 5, wherein the controller resets the value counted in the count means by a predetermined condition.

7. A gaming machine comprising:
a display that has an arrangement area of a matrix type and arranges a plurality of symbols in the arrangement area;
a first game value insertion means that inserts a game value;
a second game value insertion means that inserts a game value;
a count means that calculates a count; and
a controller that operates:
(d1) to rearrange the symbols so that a timing at which the symbols are rearranged in at least one arrangement area is different from a timing at which the symbols are rearranged in another arrangement area, after a game value is inserted in the first game value insertion means;
(d2) to generate a step in which there is a possibility that a predetermined combination is generated due to a relation between symbols of an area already rearranged and symbols to be rearranged in any one rearrangement area, before the symbols are rearranged in that area;
(d3) to award a base payout, when the predetermined combination is generated by the symbols rearranged;
(d4) to calculate the count, when a game value is inserted into the second game value insertion means and the predetermined combination is not generated by the symbols rearranged; and
(d5) to award a special payout, when the count reaches a predetermined value.

8. The gaming machine according to claim 7, wherein the controller resets the value counted in the count means by a predetermined condition.

9. A playing method of a gaming machine that arranges a plurality of symbols in an arrangement area of a matrix type provided to a display, the method comprising the steps of:
rearranging the symbols so that a timing at which the symbols are rearranged in at least one arrangement area is different from a timing at which the symbols are rearranged in another arrangement area, after a game value is inserted;
generating a step in which there is a possibility that a predetermined combination is generated due to a relation between symbols of an area already rearranged and symbols to be rearranged in any one rearrangement area, before the symbols are rearranged in that area;
awarding a base payout, when the predetermined combination is generated by the symbols rearranged;
calculating a count of a count means, when the predetermined combination is not generated by the symbols rearranged; and
awarding a special payout, when the count reaches a predetermined value.
